(19) United States
(12) Patent Application Publication
(10) Pub. No.: US 2026/0138366 A1
(43) Pub. Date: May 21, 2026

(54) LIQUID EJECTION HEAD AND PRINTING APPARATUS

(71) Applicant: CANON KABUSHIKI KAISHA, Tokyo (JP)

(72) Inventors: YOSUKE TAKAGI, Kanagawa (JP); CHIAKI MURAOKA, Saitama (JP); YUJI TAMARU, Tokyo (JP); KIMIYUKI HAYASAKI, Kanagawa (JP); TAKUHIRO OGUSHI, Kanagawa (JP); HISAO OKITA, Kanagawa (JP); TOMOO IIZUMI, Kanagawa (JP)

(21) Appl. No.: 19/394,437

(22) Filed: Nov. 19, 2025

(30) Foreign Application Priority Data
Nov. 20, 2024 (JP) 2024-202644

(51) Int. Cl. B41J 2/045; B41J 2/175; B41J 2/18

(52) U.S. Cl. CPC B41J 2/0457; B41J 2/0451; B41J 2/04541; B41J 2/0455; B41J 2/04586; B41J 2/17596; B41J 2/18

(57) ABSTRACT

A liquid ejection head includes: a drive unit capable of performing at least one of drive of circulating liquid and drive of ejecting the liquid based on a print signal; and a monitoring unit configured to set at least one of the drive of circulating the liquid and the drive of ejecting the liquid as a monitoring target, and monitor at least one of a signal supplied to the monitoring target and a drive voltage supplied to the monitoring target, based on a predetermined setting value, and the setting value is set to be non-rewritable.

### BACKGROUND

### Field of the Technology

The present disclosure relates to a technique of a liquid ejection head that ejects liquid while circulating the liquid.

### Description of the Related Art

A technique of circulating liquid (hereinafter, also referred to as ink) in a circulation flow path communicating with ejection orifices has been conventionally known in a field of inkjet printer. Moreover, Japanese Patent Laid-Open No. 2020-185747 (hereinafter, referred to as Literature 1) describes a technique of a diagnosis circuit that diagnoses whether a print head (hereinafter, also referred to as a liquid ejection head) configured to eject liquid can normally operate or not by detecting whether a voltage value attributable to an operation of piezoelectric elements or the like is normal or not in the print head.

However, in the case where the diagnosis circuit described in Patent Literature 1 diagnoses whether the liquid ejection head can normally operate or not by detecting abnormality in the voltage value, there is a possibility that a setting value for detecting abnormality in the voltage value is rewritten in the first place. Therefore, there are cases where the diagnosis circuit cannot correctly diagnose whether the liquid ejection head can normally operate or not. Moreover, the diagnosis circuit described in Patent Literature 1 merely, electrically connects two wiring lines to each other in the case where the diagnosis circuit diagnoses that the liquid ejection head can normally operate, and this does not necessary lead to stop of the operation in the case where the liquid ejection head cannot normally operate. Specifically, in a conventional technique as described in Patent Literature 1, the liquid ejection head sometimes cannot be safely stopped in the case where electrical abnormality occurs.

### SUMMARY

An object of the present disclosure is to achieve safe stop even in the case where electrical abnormality occurs.

A liquid ejection head according to one aspect of the present disclosure includes: a drive unit capable of performing at least one of drive of circulating liquid and drive of ejecting the liquid based on a print signal; and a monitoring unit configured to set at least one of the drive of circulating the liquid and the drive of ejecting the liquid as a monitoring target, and monitor at least one of a signal supplied to the monitoring target and a drive voltage supplied to the monitoring target based on a predetermined setting value, and the setting value is set to be non-rewritable.

Features of the present disclosure will become apparent from the following description of embodiments with reference to the attached drawings. The following description of embodiments is described by way of example.

### BRIEF DESCRIPTION OF THE DRAWINGS

FIG. 1A is a schematic perspective diagram of a liquid ejection apparatus;

FIG. 1B is a block diagram of a control system of the liquid ejection apparatus;

FIG. 2 is an exploded perspective diagram of a liquid ejection head in FIGS. 1A and 1B according to a first embodiment;

FIG. 3 is a schematic configuration diagram of an ink circulation unit in FIG. 2 according to the first embodiment;

FIG. 4 is a schematic diagram of an ink circulation path through which liquid is circulated by a circulating pump in FIG. 3 according to the first embodiment;

FIG. 5 is a diagram illustrating a wiring example of the circulating pump in FIG. 4 according to the first embodiment;

FIG. 6 is a cross-sectional schematic diagram of the circulating pump in FIG. 5 according to the first embodiment;

FIG. 7 is a block diagram of a monitoring system of a liquid ejection head drive unit according to the first embodiment;

FIG. 8 is a block diagram of a monitoring system of an ejection unit according to the first embodiment;

FIG. 9 is a block diagram in which the monitoring system of the ejection unit according to the first embodiment includes a voltage divider circuit;

FIG. 10 is a block diagram in which a monitoring system of the ejection unit according to a second embodiment includes a main body signal generation circuit and a peak hold circuit;

FIG. 11 is a block diagram in which the monitoring system of the ejection unit according to the second embodiment includes the main body signal generation circuit, the voltage divider circuit, and the peak hold circuit;

FIG. 12 is a block diagram in which a monitoring system of the ink circulation unit according to a third embodiment includes the main body signal generation circuit and the peak hold circuit;

FIG. 13 is a block diagram in which the monitoring system of the ink circulation unit according to the third embodiment includes the main body signal generation circuit, the voltage divider circuit, and the peak hold circuit;

FIG. 14 is a block diagram in which a monitoring system of the ejection unit according to a fourth embodiment includes a circuit control unit and a booster circuit;

FIG. 15 is a block diagram in which the monitoring system of the ejection unit according to the fourth embodiment includes the circuit control unit, the booster circuit, and the voltage divider circuit;

FIG. 16 is a block diagram in which a monitoring system of the ink circulation unit according to a fifth embodiment includes a head information storage unit, the circuit control unit, a booster circuit, and an output switch circuit;

FIG. 17 is a block diagram in which the monitoring system of the ink circulation unit according to the fifth embodiment includes the head information storage unit, the circuit control unit, the booster circuit, the voltage divider circuit, and the output switch circuit; and

FIG. 18 is a block diagram in which a monitoring system of the ejection unit according to a sixth embodiment includes the circuit control unit, a booster circuit, and a voltage divider circuit, and the monitoring system of the ink circulation unit includes the circuit control unit, a booster circuit, a voltage divider circuit, and the output switch circuit.

### DESCRIPTION OF THE EMBODIMENTS

Preferred embodiments of the present disclosure are explained below in detail with reference to the attached drawings. Note that the following embodiments do not limit the matters of the present disclosure, and not all of combinations of features explained in the following embodiments are necessarily essential for solving means of the present disclosure. Note that the same constitutional elements are denoted by the same reference numerals.

### Outline

Various printing methods have been conventionally put to practical use to print an image on a print medium such as paper. Such printing methods include, for example, a thermal transfer method, a wire dot method, a thermos-sensitive method, and an inkjet method. Among these printing methods, the inkjet method is gathering attention due to its various characteristics, and is used in a wide variety of fields. For example, such characteristics include a characteristic of low running cost and a characteristic of low printing noise. Moreover, in the inkjet method, a printing element board provided in a liquid ejection head is driven. Ink ejection orifices are provided on a surface of the printing element board. The ink ejection orifices are formed by a nozzle member. In the case where the printing element board is driven, ink liquid droplets are ejected from the ink ejection orifices. The liquid ejection head causes these ink liquid droplets to land at desired positions on an ejection medium P, and an image is thereby printed on the ejection medium P.

Actuators configured to control ejection of inks are provided at positions corresponding to the ejection orifices. Driving the actuators causes the inks to be ejected to the ejection medium P. In order to apply energy necessary for ejection to the inks, high voltage signals need to be supplied to the actuators.

Moreover, in recent years, in the inkjet method, there is a demand for an ink-circulation type printing apparatus in which a special ink suiting the ejection medium P can be used to output a printed product with high image quality. The ink-circulation type printing apparatus as described above is also provided with the liquid ejection head. For such a liquid ejection head, the above-mentioned Patent Literature 1 propose a configuration in which the liquid ejection head is provided with an ink supply channel and an ink collection channel, and a differential pressure is generated between the ink supply channel and the ink collection channel to achieve an ink circulatory flow. The above-mentioned Patent Literature 1 discloses a liquid ejection head including two reservoirs for supplying and circulating the ink, a pump (also referred to as actuator) configured to transport ink between the two reservoirs, a pressure sensor, and a drive circuit configured to drive the pump according to an output of the pressure sensor. Supply of a high-voltage signal to the pump is necessary also in such a liquid ejection head to obtain a necessary ink flow rate.

A voltage and a signal that are a drive source for controlling the ink ejection or the ink flow rate as explained above are sent from a printing apparatus main body to the liquid ejection head. Such a voltage is a high drive voltage. Moreover, such a signal is a control signal of a print operation performed by the liquid ejection head. Accordingly, in the case where electrical abnormality occurs in the voltage or the signal sent from the printing apparatus main body to the liquid ejection head, it is necessary to appropriately detect the abnormality and safely stop the liquid ejection head. Patent Literature 1 discloses the liquid ejection head including an integrated circuit in which a diagnosis circuit is mounted, the diagnosis circuit configured to diagnose whether formation of dots satisfying print quality is possible or not.

However, in the liquid ejection head including the above-mentioned diagnosis circuit, in the case where setting value set in the integrated circuit is rewritten by a certain effect, the diagnosis circuit mounted in the integrated circuit sometimes cannot correctly perform abnormality determination in the first place. Accordingly, a configuration in which the setting value set in the integrated circuit is not rewritten is necessary as a base of diagnosing whether to safely stop the liquid ejection head or not. Moreover, the above-mentioned diagnosis circuit merely electrically connects two wiring lines in the case where the diagnosis circuit diagnoses that the liquid ejection head can normally operate, and this does not necessary lead to stop of the operation in the case where the liquid ejection head cannot normally operate. In other words, the liquid ejection head sometimes cannot be safely stopped in the case where electrical abnormality occurs.

Accordingly, in the present disclosure, the liquid ejection head includes a drive unit and a monitoring unit. The drive unit can perform drive of circulating liquid and drive of ejecting the liquid based on a print signal. The monitoring unit sets the drive unit as a monitoring target, and monitors at least one of a signal supplied to the monitoring target and a drive voltage supplied to the monitoring target, based on setting value. The setting value is set to be non-rewritable. Since rewriting of the setting value can be avoided in such a configuration, whether the liquid ejection head can normally operate or not can be correctly diagnosed. Moreover, in the present disclosure, in the case where the drive voltage exceeds a range determined by the setting value, the monitoring unit stops supply of at least one of the signal and the drive voltage to the monitoring target. In such a configuration, the supply of at least one of the signal and the drive voltage that are a drive source of an operation is stopped even in the case where the liquid ejection head cannot normally operate. Accordingly, the drive of the liquid ejection head can be surely stopped. At least one of setting by hardware and setting by software is assumed to be adopted as the setting of disabling rewriting of the setting value. For example, execution of erroneous rewriting of the setting value may be avoided by using a read only memory (ROM) as a storage medium storing the setting value. Alternatively, execution of rewriting and destruction of the setting value may be avoided by adopting a configuration in which the storage medium storing the setting value is entirely covered with a magnetic shield to prevent data destruction caused by a strong magnetic field. Alternatively, in the case where a switching mechanism used for switching between inhibiting and permitting of writing into the storage medium storing the setting value is mounted on the board, this switching mechanism is set to writing inhibited to avoid rewriting of the setting value. Alternatively, a JTAG interface of a field programmable gate array (FPGA) may be set to a physically unusable state to avoid rewriting of the setting value. Alternatively, in the case where an operating system (OS) of Windows is used, a write inhibiting number may be set for registry keys such that execution of rewriting of the setting value is not accepted in the first place. Alternatively, a file attribute of a logical file including the setting value may be set to writing inhibited with administrator rights to avoid rewriting of the setting value. Alternatively, a password may be requested in writing of the logical file including the setting value to avoid rewriting of the setting value. Note that the present disclosure is not limited to a particular embodiment as long as the configuration is such that the setting value cannot be rewritten. Details of the present disclosure are explained below.

### First Embodiment

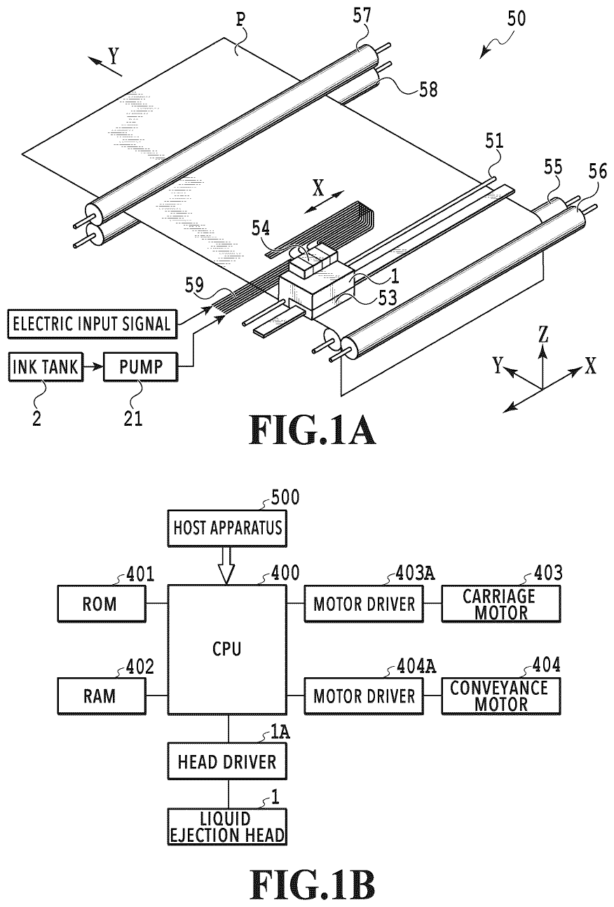

FIGS. 1A and 1B are schematic configuration diagrams of a liquid ejection apparatus 50 of the present disclosure according to a first embodiment. FIG. 1A is a schematic perspective diagram of the liquid ejection apparatus 50. FIG. 1B is a block diagram of a control system of the liquid ejection apparatus 50. The liquid ejection apparatus 50 includes a liquid ejection head 1 and conveyance rollers 55, 56, 57, and 58. The liquid ejection head 1 can perform scanning in a direction X intersecting a conveyance direction Y of the ejection medium P. In the example of FIG. 1A, the liquid ejection head 1 is mounted in a carriage 53. The carriage 53 reciprocally moves in a main scanning direction (also referred to as direction X) along a guide shaft 51. The conveyance rollers 55, 56, 57, and 58 convey the ejection medium P in a sub scanning direction (also referred to as conveyance direction Y) intersecting (orthogonal to in the present embodiment) the main scanning direction. In other words, the liquid ejection apparatus 50 is configured as a serial inkjet liquid ejection apparatus by being configured to eject liquids from the liquid ejection head 1 to the ejection medium P conveyed in the conveyance direction Y while performing scanning of the liquid ejection head 1 in the direction X. Note that application of the present disclosure is not limited to the serial inkjet liquid ejection apparatus. The present disclosure can be also applied to a page-wide type inkjet liquid ejection apparatus that ejects the liquids to the ejection medium P conveyed in the conveyance direction Y by using a line head (page-wide head) elongated in a page width direction of the ejection medium P. In FIG. 1A, a direction Z illustrates the vertical direction. In other words, the direction Z is a direction intersecting (orthogonal to in the present embodiment) an XY plane defined by the direction X and the conveyance direction Y. Note that, in the following explanation, the direction X, the conveyance direction Y, and the direction Z are used in the same meanings as the contents described above.

The liquid ejection head 1 can eject four types of inks of black (K), cyan (C), magenta (M), and yellow (Y). The liquid ejection head 1 can eject a full-color image by using the four types of inks. Note that the inks that can be ejected from the liquid ejection head 1 are not limited to the four types of inks described above. For example, the present disclosure can be applied also to a liquid ejection head 1 for ejecting other types of ink such as a spot color ink. In other words, the types of inks and the number of types of inks ejected from the liquid ejection head 1 are not limited. Moreover, a cap member configured to cover a face surface of the liquid ejection head 1 may be arranged at a position outside a conveyance path of the ejection medium P. The cap member is moved relative to the liquid ejection head 1 to a position where the cap member covers the face surface of the liquid ejection head 1 in the case where a print operation is not performed. This operation can prevent drying of ejection orifices of the liquids in the liquid ejection head 1 or enable execution of a suction operation for filling or recovery.

In an example of FIG. 1A, ink circulation units 54 are mounted in the liquid ejection head 1. A guide 59 housing four ink supply tubes (liquid communication paths) is attached to the ink circulation units 54. The guide 59 houses electric wiring lines and air pipes necessary for ejection of the liquids, in addition to the ink supply tubes. Moreover, ink tanks 2 and pumps 21 are provided on the main body (not illustrated) side of the liquid ejection apparatus 50. The ink tanks 2 store the inks. The inks stored in the ink tanks 2 are supplied to the ink circulation units 54 via the four ink supply tubes by drive force of the pumps 21. The configuration may be such that the liquid ejection head 1 is provided integrally with the ink circulation units 54, and is removable from or attachable to the carriage 53. Alternatively, the configuration may be such that the ink circulation units 54 are provided integrally with the carriage 53 and only the ink circulation units 54 are removable from or attachable to the carriage 53. Note that, in the following explanation, an example in which the liquid ejection head 1 includes the ink circulation units 54 is explained.

A CPU 400 in FIG. 1B performs various types of control in the liquid ejection apparatus 50. Programs for various processing procedures and the like are stored in a ROM 401. The CPU 400 obtains the programs for processing procedures and the like from the ROM 401. The CPU 400 controls the liquid ejection apparatus 50 based on the obtained programs. The CPU 400 uses a RAM 402 as a work area in which the programs obtained from the ROM 401 are executed. The CPU 400 obtains image data from a host apparatus 500 provided outside the liquid ejection apparatus 50. The CPU 400 controls a head driver 1A based on the obtained image data. The head driver 1A controls liquid ejection by the liquid ejection head 1. Moreover, the CPU 400 controls a motor driver 403A. The motor driver 403A controls a carriage motor 403. The carriage motor 403 moves the carriage 53 along the X direction. The CPU 400 controls a motor driver 404A. The motor driver 404A controls a conveyance motor 404. The conveyance motor 404 controls the conveyance rollers 55, 56, 57, and 58. The conveyance rollers 55, 56, 57, and 58 convey the ejection medium P along the conveyance direction Y.

### Liquid Ejection Head 1

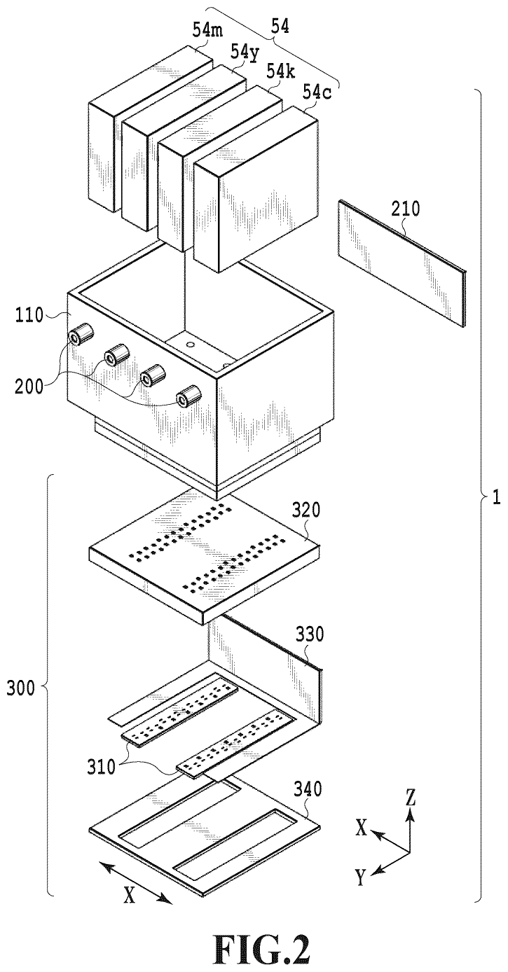

FIG. 2 is an exploded perspective diagram of the liquid ejection head 1 in FIGS. 1A and 1B according to the first embodiment. The liquid ejection head 1 includes a flow path member 110, the ink circulation units 54, and an ejection unit 300. The ink circulation units 54 are at least partially housed in the flow path member 110, and is connected to the flow path member 110. The ejection unit 300 is provided in a bottom portion of the flow path member 110, and is connected to the flow path member 110. Specifically, the ink circulation units 54 include ink circulation units 54m, 54y, 54k, and 54c corresponding to the respective inks. In the case where the ink circulation units 54m, 54y, 54k, and 54c are not particularly distinguished from one another, the ink circulation units 54m, 54y, 54k, and 54c are referred to as the ink circulation units 54. Each of the ink circulation units 54 is housed in and connected to the flow path member 110. Each of the ink circulation units 54 and the flow path member 110 may be connected to each other in a screw-fastening method with a sealing member sandwiched between the ink circulation unit 54 and the flow path member 110. Alternatively, each of the ink circulation units 54 and the flow path member 110 may be connected to each other by welding. The flow path member 110 has a surface provided with four joints 200 connected to the four ink supply tubes corresponding to the four types of inks, respectively. In other words, individual ink supply channels are provided for the respective types of inks. Specifically, the ink circulation units 54m, 54y, 54k, and 54c are connected to the respective ink supply tubes corresponding to the respective inks and extending from the main body side of the liquid ejection apparatus 50, via the respective joints 200. The respective inks supplied from the respective corresponding ink supply tubes are supplied to the ink circulation units 54 via the respective joints 200. The respective inks supplied to the ink circulation units 54 are supplied to the ejection unit 300 via the flow path member 110.

The ejection unit 300 includes ejection element boards 310, a supporting member 320, an electric wiring board 330, and a cover member 340. The ejection element boards 310 and the electric wiring board 330 are bonded and fixed to the supporting member 320. The cover member 340 is bonded and joined to cover a surface of the electric wiring board 330. Portions of the cover member 340 corresponding to the ejection element boards 310 are opened. The ejection element boards 310 include actuators configured to eject the inks. Accordingly, the ejection element boards 310 can eject the liquids to the ejection medium P passing below the liquid ejection head 1. Note that the ejection unit 300 and the flow path member 110 are bonded to each other by using an adhesive agent. Alternatively, the ejection unit 300 and the flow path member 110 may be fixed by screw fastening with a sealing member sandwiched between the ejection unit 300 and the flow path member 110.

The ejection element boards 310 and the electric wiring board 330 are electrically connected to each other by wire bonding. The electric wiring board 330 sends various electric signals to the ejection element boards 310. The ejection element boards 310 eject the liquids by using the drive voltage supplied from the head driver 1A, depending on the various electric signals from the electric wiring board 330. Details of the various electric signals are described later. Note that the ejection element boards 310 and the electric wiring board 330 may be electrically connected to each other by flying lead bonding or the like.

A contact surface is provided on the opposite side of the flow path member 110 to the surface provided with the joints 200. A head board 210 is connected to the contact surface. The head board 210 receives electric signals from the main body of the liquid ejection apparatus 50. The head board 210 and the electric wiring board 330 are electrically connected to each other. The electric signals received by the head board 210 are sent to the ejection element boards 310 via the electric wiring board 330. Note that the head board 210 and the flow path member 110 may be fixed to each other by crimping, adhesive, or a two-sided adhesive tape. Moreover, the head board 210 and a carriage board 220 may be electrically connected to each other by being fixed by anisotropic conductive film (ACF) pressure bonding. Furthermore, the head board 210 and the electric wiring board 330 may be electrically connected to each other by wire bonding. Alternatively, the head board 210 and the electric wiring board 330 may be electrically connected to each other by flying lead bonding.

### Ink Circulation Path

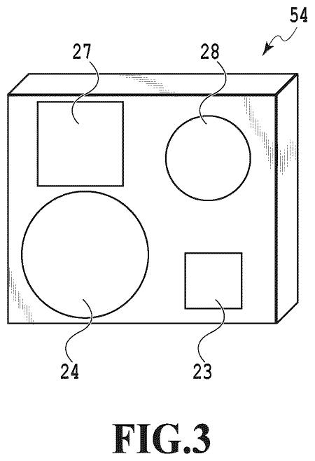

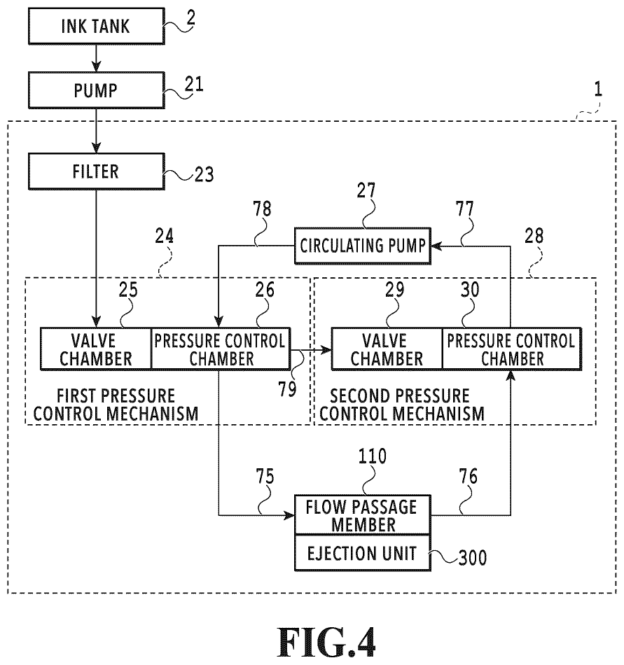

FIG. 3 is a schematic configuration diagram of each of the ink circulation units 54 in FIG. 2 according to the first embodiment. One ink circulation unit 54 is arranged for each color. The ink circulation unit 54 includes a first pressure control mechanism 24, a second pressure control mechanism 28, a filter 23, and a circulating pump 27. FIG. 4 is a schematic diagram of an ink circulation path through which the liquid is circulated by the circulating pump 27 in FIG. 3 according to the first embodiment. The ink circulation path of FIG. 4 is an ink circulation path for one color. The ink circulation path of FIG. 4 is provided for each ink in the liquid ejection head 1. The ink tank 2 and the pump 21 are provided on the main body side of the liquid ejection apparatus 50. The first pressure control mechanism 24 includes a valve chamber 25 and a pressure control chamber 26. The valve chamber 25 and the pressure control chamber 26 communicate with each other via a not-illustrated valve. The second pressure control mechanism 28 includes a valve chamber 29 and a pressure control chamber 30. The valve chamber 29 and the pressure control chamber 30 communicate with each other via a not-illustrated valve. The circulating pump 27 and the pressure control chamber 26 are connected to each other via a pump outlet flow path 78. The pressure control chamber 26 and the flow path member 110 are connected via a supply flow path 75. Part of the flow path member 110 may form the supply flow path 75. The flow path member 110 and the pressure control chamber 30 are connected via a collection flow path 76. Part of the flow path member 110 may form the collection flow path 76. The pressure control chamber 30 and the circulating pump 27 are connected via a pump inlet flow path 77. In other words, the ink circulation path is formed of the pressure control chamber 26, the supply flow path 75, the flow path member 110, the collection flow path 76, the pressure control chamber 30, the pump inlet flow path 77, the circulating pump 27, and the pump outlet flow path 78. The ink can be circulated through this ink circulation path. Next, details of the circulating pump 27 are explained, and then a flow of the ink circulated through the ink circulation path is explained.

### Drive Mechanism of Circulating pump 27

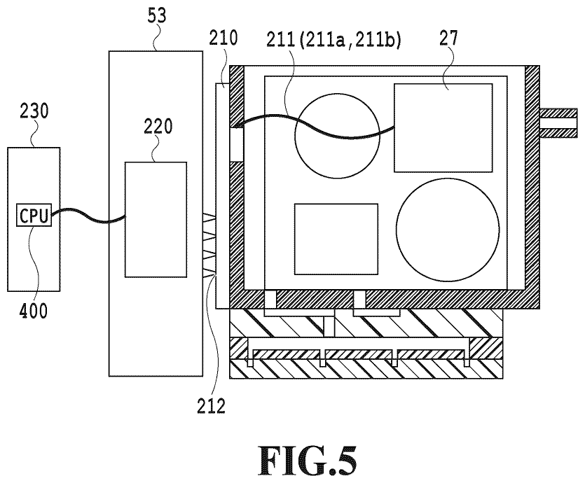

FIG. 5 is a diagram illustrating a wiring example of the circulating pump 27 in FIG. 4 according to the first embodiment. A main board 230 is provided in the main body of the liquid ejection apparatus 50. The CPU 400 is mounted on the main board 230. The carriage board 220 is provided in the carriage 53. The main board 230 and the carriage board 220 are connected via a flexible flat cable (FFC). A drive signal is sent from the CPU 400 to the carriage board 220 via the FFC. The carriage board 220 and the head board 210 are contact-connected via electric connection portions 212. A pump control signal and a pump drive reference voltage are sent from the carriage board 220 to the head board 210 via the electric connection portions 212. The head board 210 and the circulating pump 27 are connected via a harness 211. The harness 211 is formed of a cable assembly including a first wiring line 211a and a second wiring line 211b. A pump drive signal is generated, based on the pump control signal and based on a pump drive voltage generated from the pump drive reference voltage, and the pump drive signal is outputted to the circulating pump 27 via the harness 211. The circulating pump 27 is driven based on the pump drive signal, and the liquid is circulated. Note that, in the following explanation, each of the head board 210, the carriage board 220, the electric connection portions 212, the electric wiring board 330, and the ejection element board 310 is assumed to be connected to the ground. Moreover, explanation is given assuming that a voltage is a potential difference between a reference potential that is the potential of the ground and a potential of a comparison target. For example, the voltage of the pump control signal indicates a voltage of a difference between the potential of the pump control signal and the reference potential.

### Configuration of Circulating Pump 27

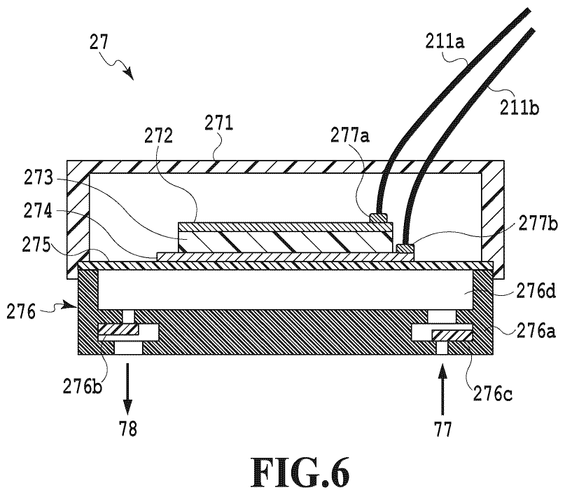

FIG. 6 is a cross-sectional schematic diagram of the circulating pump 27 in FIG. 5 according to the first embodiment. The first wiring line 211a is connected to a first electrode 272 via an electric connection member 277a. The second wiring line 211b is connected to a second electrode 274 via an electric connection member 277b. Although the electric connection members 277a and 277b are solder in the present embodiment, the electric connection members 277a and 277b are not limited to this. Conductive members such as gold bumps may be used as the electric connection members 277a and 277b. A piezoelectric element 273 is provided between the first electrode 272 and the second electrode 274. One surface of the piezoelectric element 273 is in contact with the first electrode 272. The other surface of the piezoelectric element 273 is in contact with the second electrode 274. One surface of the second electrode 274 is in contact with the piezoelectric element 273, and the other surface of the second electrode 274 is in contact with a diaphragm 275. In other words, a laminated body in which the first electrode 272, the piezoelectric element 273, the second electrode 274, and the diaphragm 275 are stacked one on top of another in this order is formed. A pump case 271 is provided to cover the laminated body. Moreover, of the two surfaces of the diaphragm unit 276 is provided on the surface opposite to the surface on which the laminated body is formed. The diaphragm unit 276 includes a diaphragm unit housing 276a, a valve element 276b, and a valve element 276c. The diaphragm unit housing 276a is formed of a recess-shaped housing. Fixing a rim of the recess shape of the diaphragm unit housing 276a and a rim of the diaphragm 275 to each other in a state where the rims are in contact with each other forms a pressure chamber 276d. The valve element 276b and the valve element 276c are provided at positions away from each other at a certain interval in a bottom portion of the diaphragm unit housing 276a in a state where the valve element 276b and the valve element 276c can freely move depending on flow-out of the liquid from the pressure chamber 276d and flow-in of the liquid into the pressure chamber 276d to function as valves. The pump outlet flow path 78 of FIG. 4 is arranged at a position opposing the valve element 276b. The pump inlet flow path 77 of FIG. 4 is arranged at a position opposing the valve element 276c. Next, the flow of the ink is explained by using FIG. 4.

### Flow of Ink

Returning to FIG. 4, the pump 21 of FIG. 4 pressurizes and supplies the ink stored in the ink tank 2 to the liquid ejection head 1. The filter 23 removes dust included in the ink pressurized and supplied from the pump 21. The ink from which dust is removed by the filter 23 is supplied to the valve chamber 25 of the first pressure control mechanism 24. The circulating pump 27 controls the pressure of the ink supplied to the valve chamber 25 in the case where the ink flows into the pressure control chamber 26. Next, details of the control of pressure by the circulating pump 27 are explained by using FIG. 6.

An inner volume of the pressure chamber 276d is changed by generating a potential difference in the piezoelectric element 273 of FIG. 6, and the pressure inside the pressure chamber 276d is changed. The pressure change inside the pressure chamber 276d causes the two valve elements 276b and 276c to alternately move and send the ink, and the circulating pump 27 thereby functions as a piezoelectric diaphragm pump. The circulating pump 27 is driven to send the ink, where the pump inlet flow path 77 is on the downstream side and the pump outlet flow path 78 is on the upstream side. Returning to FIG. 4, driving the circulating pump 27 of FIG. 4 causes the ink whose pressure is controlled inside the pressure control chamber 26 to be supplied to the supply flow path 75 and a bypass flow path 79. The supply flow path 75 supplies the ink to the flow path member 110. The flow path member 110 supplies the ink supplied from the supply flow path 75, to the ejection unit 300. The ink supplied to the ejection unit 300 is supplied to the ejection element board 310 inside the ejection unit 300. Ejection elements are provided in the ejection element board 310. The ink supplied to the ejection element board 310 passes the ejection elements, and is then discharged to the collection flow path 76. The ejection elements include energy generation elements, pressure chambers, and the ejection orifices. The ink that has passed the pressure chambers inside the ejection elements and that is discharged to the collection flow path 76 is supplied to the pressure control chamber 30. Moreover, the ink supplied to the valve chamber 29 via the bypass flow path 79 is supplied to the pressure control chamber 30 communicating with the valve chamber 29 via the valve connecting the valve chamber 29 and the pressure control chamber 30. Accordingly, the ink is supplied to the pressure control chamber 30 from each of the collection flow path 76 and the bypass flow path 79. The ink supplied to the pressure control chamber 30 is supplied to the circulating pump 27 via the pump inlet flow path 77. The ink supplied to the circulating pump 27 is supplied to the pressure control chamber 26 via the pump outlet flow path 78. As described above, the circulating pump 27 causes the ink to pass the ejection elements formed in the ejection element board 310, and circulates the ink. The ink circulation path in which the ink is circulated as described above is thereby formed. The configuration as described above can suppress thickening of the ink in the ejection elements. The ink circulation path is not limited to a configuration running through the ejection elements. For example, the ink circulation path may be configured to circulate the ink inside the ejection unit 300 as long as there is an effect of suppressing the thickening of the ink in the ejection elements. Next, the following three use cases are explained for the flow-in and the flow-out of the ink by using FIG. 6.

### Use Case 1

A use case where the ink flows into the pressure chamber 276d is explained. Assume a case where a potential difference in a direction from the second electrode 274 toward the first electrode 272 is generated, and the piezoelectric element 273 and the diaphragm 275 are displaced in a direction in which the pressure chamber 276d is expanded. In this assumed case, the valve element 276c opens, and the ink flows from the pump inlet flow path 77 into the pressure chamber 276d.

### Use Case 2

A use case where the ink flows out from the pressure chamber 276d is explained. Assume a case where a potential difference in a direction from the first electrode 272 toward the second electrode 274 is generated, and the piezoelectric element 273 and the diaphragm 275 are displaced in a direction in which the pressure chamber 276d is contracted. In this assumed case, the valve element 276b opens, and the ink flows out from the pressure chamber 276d to the pump outlet flow path 78.

### Use Case 3

A use case where neither the flow-in of the ink into the pressure chamber 276d nor the flow-out of the ink from the pressure chamber 276d occurs is explained. Assume a case where there is no potential difference between the first electrode 272 and the second electrode 274. In this assumed case, the piezoelectric element 273 and the diaphragm 275 are displaced in neither the direction in which the pressure chamber 276d is expanded nor the direction in which the pressure chamber 276d is contracted. Accordingly, neither the flow-in of the ink into the diaphragm unit 276 nor the flow-out of the ink from the diaphragm unit 276 occurs.

In other words, periodically changing the potential difference between the first electrode 272 and the second electrode 274 causes the circulating pump 27 to perform the flow-in of the ink from the pump inlet flow path 77 and the flow-out of the ink to the pump outlet flow path 78. Next, explanation is given of a process of diagnosing whether the liquid ejection head 1 can normally operate while driving the liquid ejection head 1 based on the control signal and the drive voltage.

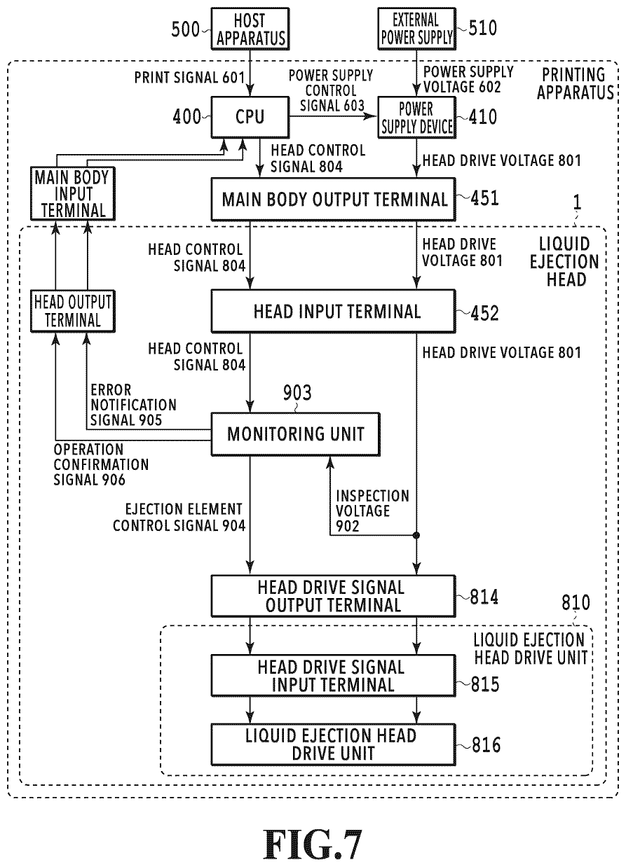

FIG. 7 is a block diagram of a monitoring system of a liquid ejection head drive unit 810 according to the first embodiment. The liquid ejection head drive unit 810 is provided inside the liquid ejection head 1, and is a generic term of a unit that can perform drive control by being supplied with at least one of a voltage and a signal. The liquid ejection head drive unit 810 performs drive of circulating the liquid and drive of ejecting the liquid based on a print signal. The drive of circulating the liquid can be implemented by, for example, the ink circulation unit 54. The drive of ejecting the liquid based on the print signal can be implemented by, for example, the ejection unit 300. A printing apparatus of FIG. 7 corresponds to the liquid ejection apparatus 50 described above. Note that the printing apparatus in the following explanation also corresponds to the liquid ejection apparatus 50 described above. The printing apparatus includes the CPU 400, a power supply device 410, a main body output terminal 451, and a main body input terminal. The CPU 400, the power supply device 410, the main body output terminal 451, and the main body input terminal are included in the main body of the liquid ejection apparatus 50 of FIG. 1. The liquid ejection head 1 includes a head input terminal 452, a monitoring unit 903, a head output terminal, a head drive signal output terminal 814, and the liquid ejection head drive unit 810. The liquid ejection head drive unit 810 includes a head drive signal input terminal 815 and a liquid ejection head drive unit 816.

A host apparatus 500 and an external power supply 510 are provided outside the printing apparatus. A print signal 601 as the image data is inputted into the CPU 400 of the printing apparatus from the host apparatus 500. In the meanwhile, a power supply voltage 602 is supplied from the external power supply 510 to the power supply device 410. The CPU 400 activates a power supply control signal 603 to the power supply device 410 by receiving the print signal 601 from the host apparatus 500. Note that, in the present embodiment, the power supply control signal 603 is assumed to be active high. In other words, the setting is assumed to be such that the power supply device 410 operates in the case where the power supply control signal 603 is high. Specifically, in the case where a signal potential of the power supply control signal 603 transitions from 0 V to 3.3 V, the power supply device 410 outputs a head drive voltage 801 to the main body output terminal 451. The CPU 400 outputs a head control signal 804 to the main body output terminal 451 by receiving an input of the print signal 601 from the host apparatus 500. The main body output terminal 451 outputs the head drive voltage 801 and the head control signal 804 to the head input terminal 452. The monitoring unit 903 is provided between the head input terminal 452 and the head drive signal output terminal 814. The head input terminal 452 and the monitoring unit 903 are provided in the head board 210. The head board 210 and the ejection element board 310 are electrically connected via the electric wiring board 330. Accordingly, the head drive signal output terminal 814 and each of the head input terminal 452 and the monitoring unit 903 are electrically connected via the electric wiring board 330. The head drive signal output terminal 814 and the head drive signal input terminal 815 are electrically connected by wire bonding or the like.

### Monitoring Unit 903

The monitoring unit 903 sets the liquid ejection head drive unit 810 as the monitoring target, and monitors at least one of a signal supplied to the monitoring target and a drive voltage supplied to the monitoring target, based on the setting value. The setting value is set to be non-rewritable. For example, the monitoring unit 903 receives an ejection element control signal 904, as the head control signal 804 that is the control signal to the liquid ejection head drive unit 810. The monitoring unit 903 diagnoses whether the ejection element control signal 904 is abnormal or not. For example, a signal potential upper limit value that is an upper limit value of the potential of the ejection element control signal 904 is set as the setting value. In the case where the ejection element control signal 904 exceeds the signal potential upper limit value, the monitoring unit 903 diagnoses that the ejection element control signal 904 is abnormal and is a signal that may break the liquid ejection head drive unit 816 (for example, ejection element board 310). Meanwhile, in the case where the monitoring unit 903 diagnoses that the ejection element control signal 904 is not abnormal, the monitoring unit 903 allows transmission of the head control signal to the liquid ejection head drive unit 816. Moreover, the monitoring unit 903 monitors the head drive voltage 801 supplied from the power supply device 410, as an inspection voltage 902. The monitoring unit 903 monitors whether the inspection voltage 902 is within a predetermined voltage range. For example, a lower limit voltage value and an upper limit voltage value which define the predetermined voltage range are set as the setting values. In this case, the setting value is at least one threshold, and in the above-mentioned example, an example of two thresholds of the lower limit voltage value and the upper limit voltage value is described as each of the setting values. The monitoring unit 903 monitors the inspection voltage 902 based on the setting values as described above. In the case where the monitoring unit 903 diagnoses that the head control signal 804 or the inspection voltage 902 is abnormal, the monitoring unit 903 sends an error notification signal 905 to the CPU 400. In the case where the CPU 400 receives the error notification signal 905, the CPU 400 stops transmission of the head control signal 804 and the head drive voltage 801. This operation prevents breakage of the liquid ejection head drive unit 816. The monitoring unit 903 continuously sends an operation confirmation signal 906 to the CPU 400 to indicate that the monitoring unit 903 itself is normally performing the monitoring operation. Therefore, in the case where abnormality such as failure occurs in the monitoring unit 903, the monitoring unit 903 does not transmit the operation confirmation signal 906 to the CPU 400. Accordingly, in the case where the CPU 400 cannot confirm an output of the operation confirmation signal 906 while the monitoring based on the setting value is continued, the CPU 400 may diagnose that there is abnormality in the liquid ejection head 1, and the CPU 400 may stop the operation of the printing apparatus.

In the present embodiment, a field programmable gate array (FPGA) is used for the monitoring unit 903. The FPGA is a general-purpose logical device. Moreover, the FPGA is an integrated circuit (IC) with high versatility in which good balance between throughput and cost is achieved. However, an implementation form of the monitoring unit 903 is not limited to a particular form as long as the functions explained above can be implemented. For example, a circuit formed of discrete elements, a programmable logic device (PLD), a micro-computer, an ASIC, or the like can be used for the monitoring unit 903. In the case where a general-purpose logical device such as the FPGA is used, there is a possibility that the monitoring cannot be normally performed if the setting value written in an internal register is rewritten by a certain effect. Accordingly, the monitoring unit 903 is desirably locked such that the setting value in the register cannot be rewritten.

In the above explanation, the liquid ejection head 1 includes the drive unit and the monitoring unit. The drive unit can perform at least one of the drive of circulating the liquid and the drive of ejecting the liquid based on the print signal. The monitoring unit sets at least one of the drive of circulating the liquid and the drive of ejecting the liquid as the monitoring target, and monitors at least one of the signal supplied to the monitoring target and the drive voltage supplied to the monitoring target, based on the setting value determined in advance. The setting value is set to be non-rewritable. Since rewriting of the setting value can be avoided in such a configuration, it is possible to correctly diagnose whether the liquid ejection head can normally operate or not. Accordingly, the liquid ejection head can be safely stopped even in the case where electrical abnormality occurs.

Moreover, in the case where the drive voltage exceeds the range determined by the setting value, the monitoring unit may stop supply of at least one of the signal and the drive voltage to the monitoring target. In this configuration, the drive of the monitoring target can be stopped in the case where the drive voltage exceeds the setting value. For example, the drive of the drive unit can be stopped even in the case where the drive voltage exceeds a withstanding voltage of the monitoring target.

Moreover, the monitoring unit may output the operation confirmation signal indicating execution of the monitoring to the outside while the monitoring is continued based on the setting value. In this configuration, if the output of the operation confirmation signal stops, this means that the monitoring based on the setting value is not performed while the monitoring is continued. Accordingly, there is possibility that a failure has occurred in the monitoring unit. This configuration enables detection of such a possibility.

### Ejection Unit 300

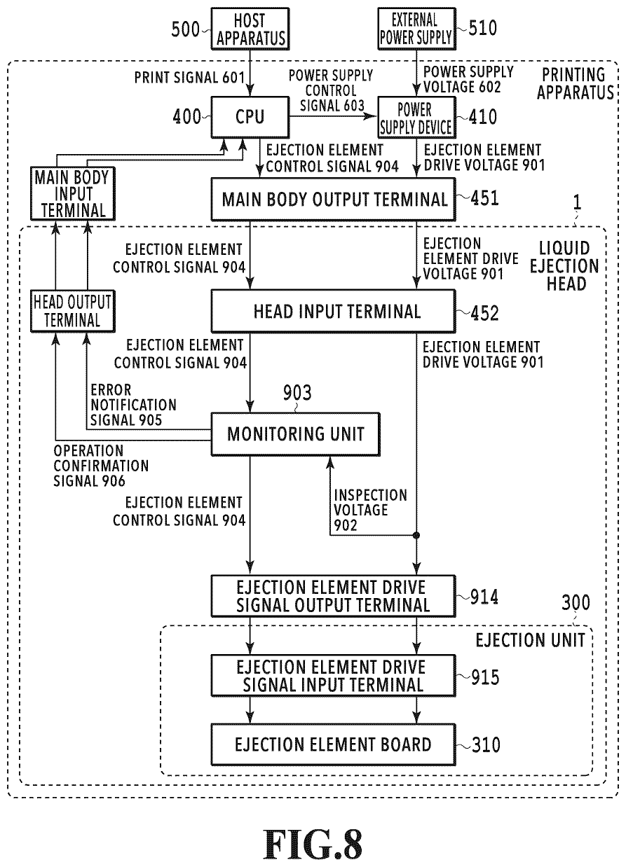

FIG. 8 is a block diagram of a monitoring system of the ejection unit 300 according to the first embodiment. Differences from FIG. 7 are mainly explained. In the case where the signal potential of the power supply control signal 603 transitions from 0 V to 3.3 V, the power supply device 410 outputs an ejection element drive voltage 901 to the main body output terminal 451. The CPU 400 outputs the ejection element control signal 904 to the main body output terminal 451 by receiving the input of the print signal 601 from the host apparatus 500. The main body output terminal 451 outputs the ejection element drive voltage 901 and the ejection element control signal 904. In the present embodiment, the ejection element drive voltage 901 is 28 V. The ejection element drive voltage 901 and the ejection element control signal 904 outputted from the main body output terminal 451 are transmitted to the liquid ejection head 1 via the head input terminal 452. The ejection element drive voltage 901 and the ejection element control signal 904 are transmitted to an ejection element drive signal output terminal 914 via the electric wiring board 330. The ejection element drive signal output terminal 914 transmits the ejection element drive voltage 901 and the ejection element control signal 904 to the ejection element board 310 via an ejection element drive signal input terminal 915. The ejection element board 310 generates an ejection element drive signal 911 based on the ejection element drive voltage 901 and the ejection element control signal 904. The ejection element board 310 performs an ejection operation by driving the ejection elements based on the ejection element drive signal 911.

The monitoring unit 903 is provided between the head input terminal 452 and the ejection element drive signal output terminal 914. The head input terminal 452 and the monitoring unit 903 are provided in the head board 210. The head board 210 and the ejection element board 310 are electrically connected via the electric wiring board 330. Accordingly, the ejection element drive signal output terminal 914 and each of the head input terminal 452 and the monitoring unit 903 are electrically connected via the electric wiring board 330. The ejection element drive signal output terminal 914 and the ejection element drive signal input terminal 915 are electrically connected by wire bonding or the like.

The monitoring unit 903 monitors the ejection element control signal supplied to the ejection element board 310, as the signal, and monitors the ejection element drive voltage supplied to the ejection element board 310, as the drive voltage. Specifically, the monitoring unit 903 receives the ejection element control signal 904, and diagnoses whether the ejection element control signal 904 instructing the print operation is an abnormal signal or not or diagnoses whether there is a possibility that the ejection element control signal 904 breaks the ejection element board 310 or not. In the case where the monitoring unit 903 determines that there is no abnormality, the monitoring unit 903 allows transmission of the ejection element control signal 904 to the ejection element board 310. Moreover, the monitoring unit 903 monitors the ejection element drive voltage 901 as the inspection voltage 902. Specifically, the monitoring unit 903 monitors whether the inspection voltage 902 is within a predetermined voltage range or not. In the case where the monitoring unit 903 diagnoses that the ejection element control signal 904 or the ejection element drive voltage 901 is abnormal, the monitoring unit 903 sends the error notification signal 905 to the CPU 400. In the case where the CPU 400 receives the error notification signal 905, the CPU 400 stops transmission of the ejection element control signal 904 and the ejection element drive voltage 901. This operation prevents breakage of the ejection element board 310. Moreover, the monitoring unit 903 continuously sends the operation confirmation signal 906 to the CPU 400 to indicate that the monitoring unit 903 itself is normally performing the monitoring operation. In the case where abnormality such as failure occurs in the monitoring unit 903, the monitoring unit 903 does not transmit the operation confirmation signal 906 to the CPU 400. Accordingly, in the case where the CPU 400 cannot confirm the output of the operation confirmation signal 906 while the monitoring based on the setting value is continued, the CPU 400 may diagnose that there is abnormality in the liquid ejection head 1, and stop the drive of the liquid ejection head 1.

### Voltage Divider Circuit 910

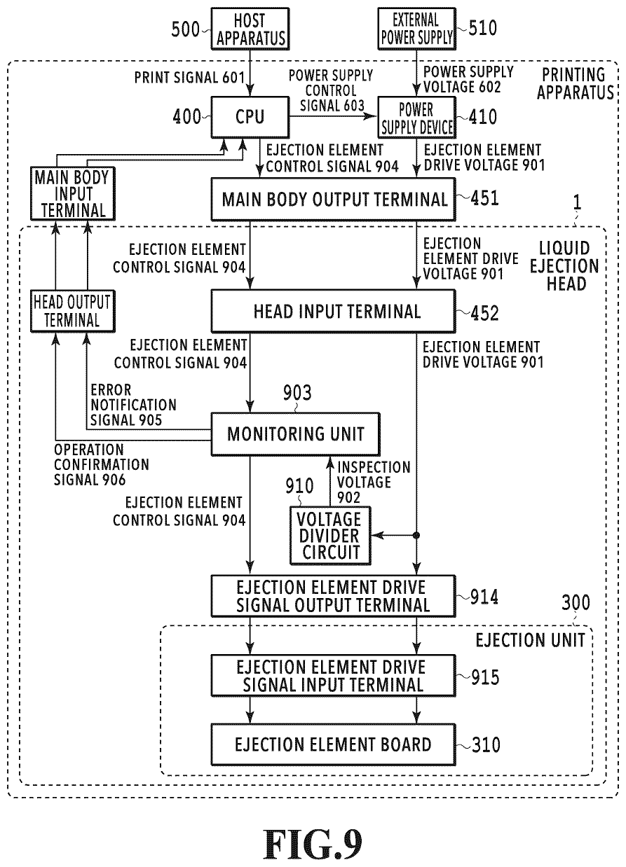

FIG. 9 is a block diagram in which the monitoring system of the ejection unit 300 according to the first embodiment includes a voltage divider circuit. In FIG. 8, explanation is given of the example in which the monitoring unit 903 monitors whether the ejection element drive voltage 901 is within the predetermined voltage range. In FIG. 9, explanation is given of an example in which a voltage divider circuit 910 is further provided, and the monitoring unit 903 monitors a divided voltage obtained by dividing the ejection element drive voltage 901.

For example, in the case where the inspection voltage 902 is a high voltage, devices with withstanding voltages capable of withstanding the inspection voltage 902 need to be selected as devices to be mounted in the monitoring unit 903. In this case, the size or the cost may increase. Moreover, there is a possibility that a degree of freedom in selection of the devices decreases. Accordingly, instead of inputting the ejection element drive voltage 901 directly into the monitoring unit 903 as the inspection voltage 902 as in FIG. 8, the inspection voltage 902 may be inputted into the monitoring unit 903 via the voltage divider circuit 910 as in FIG. 9. In other words, the ejection element drive voltage 901 is divided by the voltage divider circuit 910 into a lowered divided voltage which is inputted into the monitoring unit 903 as the inspection voltage 902, so that the monitoring unit 903 can monitor the ejection element drive voltage 901.

According to the above-mentioned explanation, the liquid ejection head 1 may further include the voltage divider circuit 910 that supplies the divided voltage, obtained by dividing the drive voltage, to the monitoring unit. The monitoring unit 903 may set the setting value to a divided voltage setting value corresponding to the divided voltage, and the monitoring unit 903 may monitor whether the divided voltage exceeds the setting value or not. This configuration enables highly-sensitive monitoring of abnormality occurring in a transmission path. Moreover, breakage of the ejection element board 310 can be prevented.

### Second Embodiment

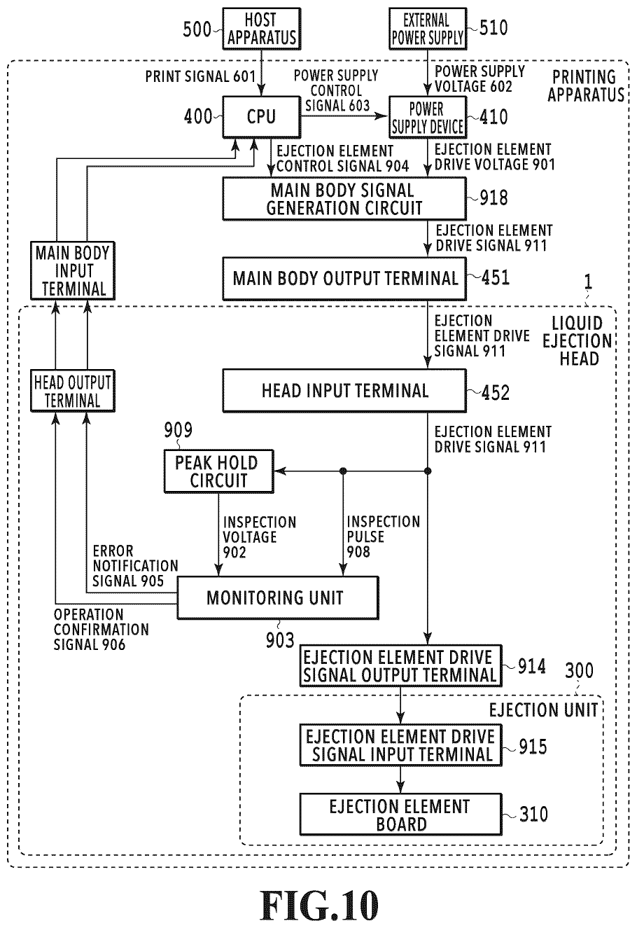

FIG. 10 is a block diagram in which a monitoring system of the ejection unit 300 according to a second embodiment includes a main body signal generation circuit and a peak hold circuit. The second embodiment is different from the first embodiment in that a main body signal generation circuit 918 provided outside the liquid ejection head 1 and in the printing apparatus main body generates the ejection element drive signal 911, and a peak hold circuit 909 provided inside the liquid ejection head 1 extracts a peak voltage of the ejection element drive signal 911. Differences from the first embodiment are mainly explained below.

The printing apparatus includes the main body signal generation circuit 918. The ejection element control signal 904 is supplied from the CPU 400 to the main body signal generation circuit 918. The ejection element drive voltage 901 is supplied from the power supply device 410 to the main body signal generation circuit 918. The main body signal generation circuit 918 generates the ejection element drive signal 911 based on the ejection element control signal 904 and based on the ejection element drive voltage 901. The potential of the ejection element drive signal 911 is a high voltage, and includes a digital signal. The ejection element drive signal 911 drives the ejection elements of the ejection element board 310. The main body signal generation circuit 918 outputs the ejection element drive signal 911 to the liquid ejection head 1 via the main body output terminal 451. The liquid ejection head 1 supplies the ejection element drive signal 911 to the peak hold circuit 909, the monitoring unit 903, and the ejection element drive signal output terminal 914 via the head input terminal 452. The ejection element drive signal output terminal 914 supplies the ejection element drive signal 911 to the ejection unit 300. The ejection unit 300 supplies the ejection element drive signal 911 to the ejection element board 310 via the ejection element drive signal input terminal 915. The ejection element board 310 performs an ink ejection operation according to the ejection element drive signal 911.

### Monitoring Unit 903

The monitoring unit 903 receives the ejection element drive signal 911 as an inspection pulse 908 via a first transmission path branching from a transmission path to the ejection element drive signal output terminal 914. The monitoring unit 903 diagnoses whether the inspection pulse 908 is a logically-abnormal signal or not. Moreover, the peak hold circuit 909 receives the ejection element drive signal 911 via a second transmission path branching from the first transmission path. The ejection element drive signal 911 includes a digital signal. The peak hold circuit 909 extracts a peak voltage of the ejection element drive signal 911. The peak hold circuit 909 generates the inspection voltage 902 based on the extracted peak voltage. The peak hold circuit 909 supplies the inspection voltage 902 to the monitoring unit 903. The monitoring unit 903 diagnoses whether the inspection voltage 902 is within a predetermined voltage range. In other words, the monitoring unit 903 may set the setting value to a peak setting value corresponding to the inspection voltage 902, and monitor whether the inspection voltage 902 exceeds the setting value or not. In the case where the monitoring unit 903 diagnoses that at least one of the inspection pulse 908 and the inspection voltage 902 is abnormal, the monitoring unit 903 sends the error notification signal 905 to the CPU 400. In the case where the CPU 400 receives the error notification signal 905, the CPU 400 stops the print operation. Moreover, the monitoring unit 903 sends the operation confirmation signal 906 to the CPU 400 to indicate that the monitoring unit 903 correctly functions. In the case where there is abnormality in the monitoring unit 903, the monitoring unit 903 does not transmit the operation confirmation signal 906 to the CPU 400 by this operation. Accordingly, in the case where the CPU 400 does not receive the operation confirmation signal 906 for a predetermined time period, the CPU 400 may detect that there is abnormality in the monitoring unit 903.

### Voltage Divider Circuit 910

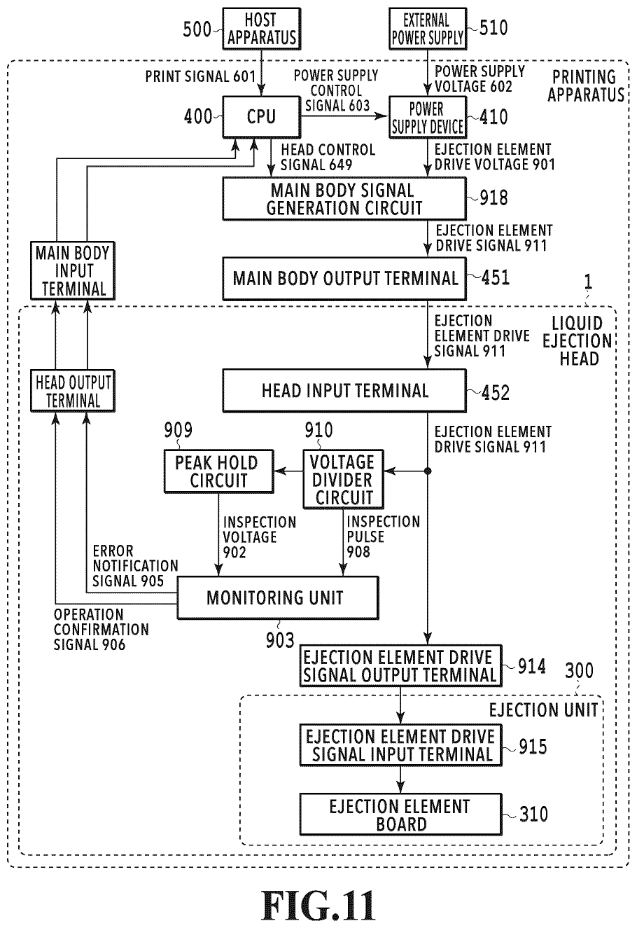

FIG. 11 is a block diagram in which the monitoring system of the ejection unit according to the second embodiment includes the main body signal generation circuit 918, the voltage divider circuit 910, and the peak hold circuit 909. The voltage divider circuit 910 outputs a divided drive signal obtained by dividing a voltage of the drive signal. For example, the voltage divider circuit 910 of FIG. 11 outputs the divided drive signal, obtained by dividing the voltage of the ejection element drive signal 911, to the peak hold circuit 909. The monitoring unit 903 sets the setting value to a divided peak setting value corresponding to the inspection voltage 902, and monitors whether the inspection voltage 902 exceeds the setting value or not. Such an operation brings the monitoring unit 903 to be able to be supplied signal which is lowered potential of voltage of the ejection element drive signal 911 through the voltage divider circuit 910. Therefore, it is possible to suppress an increase in the size or an increase in the cost, corresponding to a higher withstanding voltage of the monitoring unit 903.

### Third Embodiment

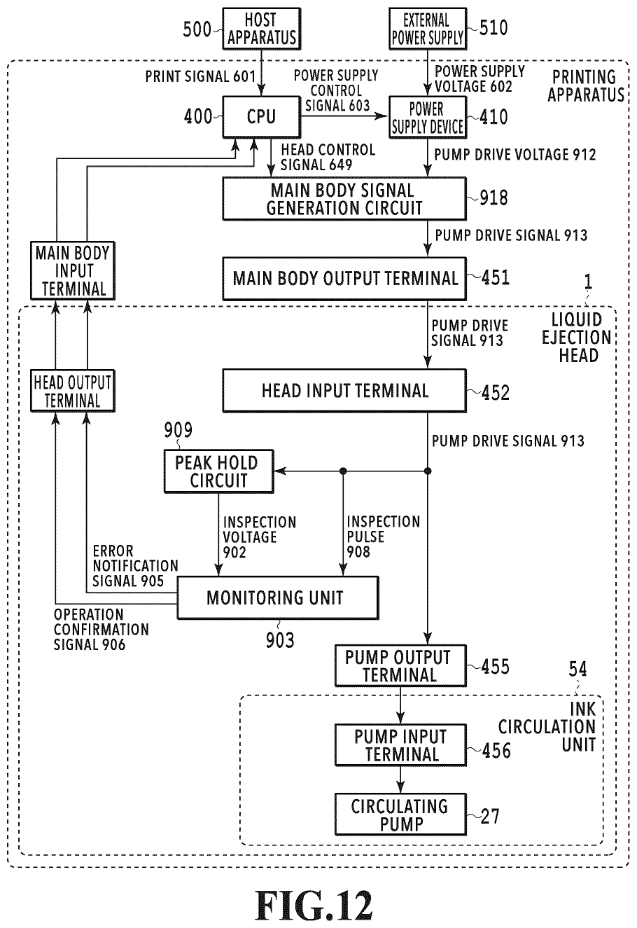

FIG. 12 is a block diagram in which a monitoring system of the ink circulation unit according to a third embodiment includes the main body signal generation circuit and the peak hold circuit. The third embodiment is different from the first embodiment in that the main body signal generation circuit 918 provided outside the liquid ejection head 1 and in the printing apparatus main body generates a pump drive signal 913, and the peak hold circuit 909 in the liquid ejection head 1 extracts a peak voltage of the pump drive signal 913. Moreover, the third embodiment is different from the second embodiment in that the ink circulation unit 54 is driven instead of the ejection unit 300. Differences from the first and second embodiments are mainly explained below.

The printing apparatus includes the main body signal generation circuit 918. A head control signal 649 is supplied from the CPU 400 to the main body signal generation circuit 918. A pump drive voltage 912 is supplied from the power supply device 410 to the main body signal generation circuit 918. The main body signal generation circuit 918 generates the pump drive signal 913 based on the head control signal 649 and based on the pump drive voltage 912. The potential of the pump drive signal 913 is a high voltage, and the pump drive signal 913 includes a digital signal. The pump drive signal 913 drives the circulating pump 27. The main body signal generation circuit 918 outputs the pump drive signal 913 to the liquid ejection head 1 via the main body output terminal 451. The liquid ejection head 1 supplies the pump drive signal 913 to the peak hold circuit 909, the monitoring unit 903, and a pump output terminal 455 via the head input terminal 452. The pump output terminal 455 supplies the pump drive signal 913 to the ink circulation unit 54. The ink circulation unit 54 supplies pump drive signal 913 to the circulating pump 27 via a pump input terminal 456. The circulating pump 27 performs the ink circulation operation according to the pump drive signal 913.

### Monitoring Unit 903

The monitoring unit 903 receives the pump drive signal 913 as the inspection pulse 908 via a first transmission path branching from a transmission path to the pump output terminal 455. The monitoring unit 903 diagnoses whether the inspection pulse 908 is a logically-abnormal signal or not. Moreover, the peak hold circuit 909 receives the pump drive signal 913 via a second transmission path branching from the first transmission path. The pump drive signal 913 includes a digital signal. The peak hold circuit 909 extracts the peak voltage of the pump drive signal 913. The peak hold circuit 909 generates the inspection voltage 902 based on the extracted peak voltage. The peak hold circuit 909 supplies the inspection voltage 902 to the monitoring unit 903. The monitoring unit 903 diagnoses whether the inspection voltage 902 is within a predetermined voltage range. In other words, the monitoring unit 903 may set the setting value to a pump setting value corresponding to the inspection voltage 902, and the monitoring unit 903 may monitor whether the inspection voltage 902 exceeds the setting value or not. In the case where the monitoring unit 903 diagnoses that at least one of the inspection pulse 908 and the inspection voltage 902 is abnormal, the monitoring unit 903 sends the error notification signal 905 to the CPU 400. In the case where the CPU 400 receives the error notification signal 905, the CPU 400 stops the print operation. Moreover, the monitoring unit 903 sends the operation confirmation signal 906 to the CPU 400 to indicate that the monitoring unit 903 correctly functions. This operation enables the CPU 400 to detect that there is abnormality in the monitoring unit 903 in the case where there is abnormality in the monitoring unit 903.

### Voltage Divider Circuit 910

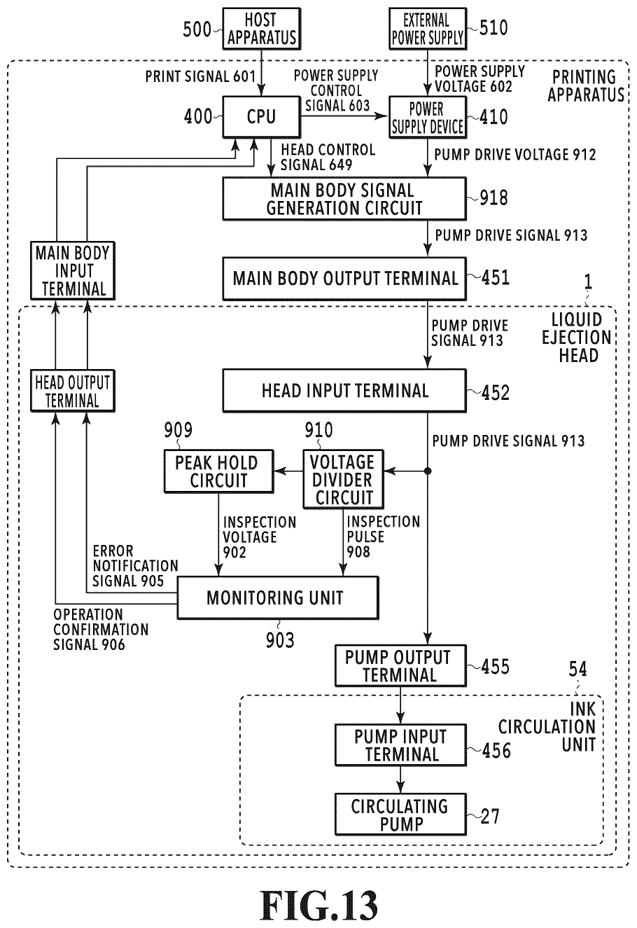

FIG. 13 is a block diagram in which the monitoring system of the ink circulation unit according to the third embodiment includes the main body signal generation circuit, the voltage divider circuit, and the peak hold circuit. The voltage divider circuit 910 outputs a divided drive signal obtained by dividing the potential of the pump drive signal 913. For example, the voltage divider circuit 910 of FIG. 13 outputs a divided pump drive signal, obtained by dividing the voltage of the pump drive signal 913, to the peak hold circuit 909. The monitoring unit 903 sets the setting value to a divided pump setting value corresponding to the inspection voltage 902, and the monitoring unit 903 monitors whether the inspection voltage 902 exceeds the setting value or not. This operation enables the monitoring unit 903 to be supplied a signal which is lowered potential of the voltage of the pump drive signal 913 through the voltage divider circuit 910. Therefore, it is possible to suppress an increase in the size or an increase in the cost, corresponding to a higher withstanding voltage of the monitoring unit 903.

### Fourth Embodiment

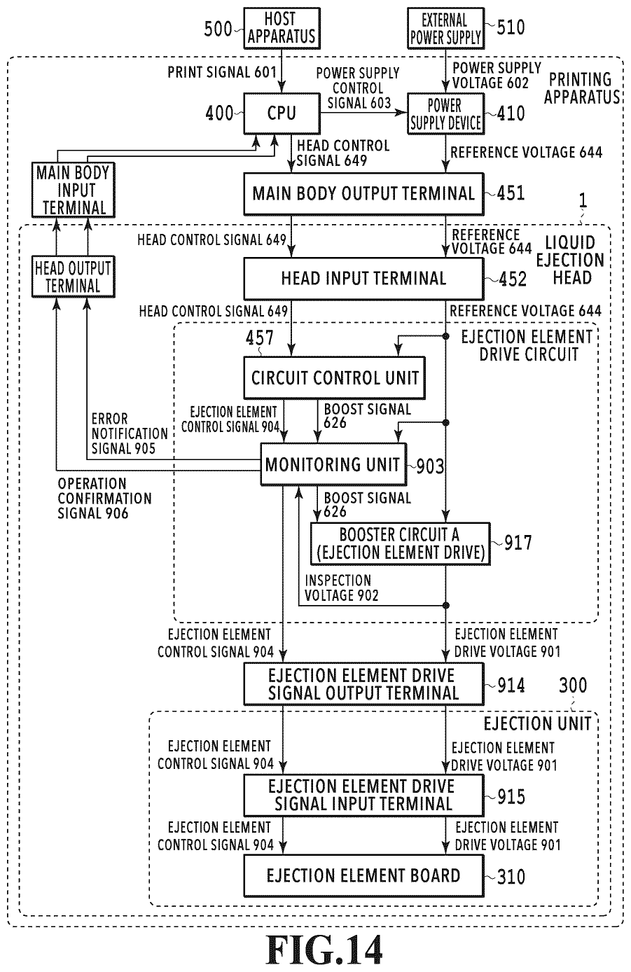

FIG. 14 is a block diagram in which a monitoring system of the ejection unit 300 according to a fourth embodiment includes a circuit control unit 457 and a booster circuit 917. The fourth embodiment is different from the first to third embodiments in that the circuit control unit 457 and a booster circuit A 917 are provided as an ejection element drive circuit in the liquid ejection head 1. Differences from the first to third embodiments are mainly explained below.

The liquid ejection head 1 includes the ejection element drive circuit. In other words, in the present embodiment, the ejection element control signal 904 and the ejection element drive voltage 901 are generated in the liquid ejection head 1. The ejection element drive circuit includes the circuit control unit 457 and the booster circuit A 917. The circuit control unit 457 and the booster circuit A 917 are provided in the head board 210. In other words, the monitoring unit 903, the circuit control unit 457, and the booster circuit A 917 are provided in the head board 210. Therefore, the monitoring unit 903, the circuit control unit 457, and the booster circuit A 917 are electrically connected in the same wiring system. Accordingly, in the case where the head board 210 is electrically affected depending on a surrounding environment of the head board 210, there is a possibility that the same offset occurs in a wiring circuit network of the head board 210.

### Circuit Control Unit 457; Monitoring Unit 903

The circuit control unit 457 receives a reference voltage 644 supplied from the power supply device 410, and the operation is started. In the present embodiment, 5 V is used as the reference voltage 644. The circuit control unit 457 receives the head control signal 649 supplied from the CPU 400. A logic circuit is provided inside the circuit control unit 457. The logic circuit outputs the ejection element control signal 904 and a boost signal 626 to the monitoring unit 903, based on the head control signal 649. The monitoring unit 903 monitors whether there is abnormality in each of the ejection element control signal 904 and the boost signal 626 or not. In the case where the monitoring unit 903 diagnoses that there is no abnormality in the ejection element control signal 904, the monitoring unit 903 transmits the ejection element control signal 904 to the ejection element board 310 via the ejection element drive signal output terminal 914. In the meanwhile, in the case where the monitoring unit 903 diagnoses that there is no abnormality in the boost signal 626, the monitoring unit 903 transmits the boost signal 626 to the booster circuit A917.

### Booster Circuit A917

The booster circuit A917 boosts the reference voltage 644 to the ejection element drive voltage 901 that is a voltage necessary for drive of the ejection elements, according to the boost signal 626. In the present embodiment, 28 V is used as the ejection element drive voltage 901. In other words, the booster circuit A917 boosts the reference voltage of 5 V to the ejection element drive voltage 901 of 28 V. The ejection element drive voltage 901 is supplied to the ejection element board 310 via the ejection element drive signal output terminal 914. The ejection element board 310 performs the liquid ejection operation based on the ejection element control signal 904 in a state where the ejection element drive voltage 901 is supplied to the ejection element board 310. Moreover, the booster circuit A917 supplies the ejection element drive voltage 901 to the monitoring unit 903 as the inspection voltage 902 via a branching path branching from a transmission path for transmitting the ejection element drive voltage 901 to the ejection element drive signal output terminal 914. The monitoring unit 903 diagnoses whether the inspection voltage 902 is within a predetermined voltage range. In the case where the monitoring unit 903 diagnoses that the inspection voltage 902 is not within the predetermined voltage range, the monitoring unit 903 diagnoses that the inspection voltage 902 is abnormal, and outputs the error notification signal 905 to the CPU 400. In the case where the CPU 400 receives the error notification signal, the CPU 400 safely stops the drive of the ejection unit 300. Moreover, the monitoring unit 903 sends the operation confirmation signal 906 to the CPU 400 to indicate that the monitoring unit 903 normally functions. This operation causes the operation confirmation signal 906 not to be sent to the CPU 400 in the case where there is abnormality in the monitoring unit 903. Accordingly, in the case where the CPU 400 does not receive the operation confirmation signal 906 for a predetermined time period, the CPU 400 may detect that there is abnormality in the monitoring unit 903.

In the present embodiment, an FPGA may be used for the circuit control unit 457, as for the monitoring unit 903. However, unlike the monitoring unit 903, the circuit control unit 457 changes an internal logic circuit setting based on the head control signal 649, and outputs the ejection element control signal 904 and the boost signal 626. Accordingly, the circuit control unit 457 needs to be a logic circuit device in which a setting value written in an internal register is rewritable. In the meanwhile, in the monitoring unit 903 of FIG. 14, the setting value in the register is desirably locked to be non-rewritable as explained by using FIG. 7.

In the above explanation, the printing apparatus further includes the booster circuit A917. The booster circuit A917 outputs the ejection element drive voltage 901 obtained by boosting the reference voltage 644. The ejection unit 300 includes the ejection element board 310 that ejects the liquid based on the ejection element drive voltage 901. The monitoring unit 903 may set the setting value to a boost setting value corresponding to the ejection element drive voltage 901, and the monitoring unit 903 may monitor whether the ejection element drive voltage 901 exceeds the setting value or not. Therefore, it is possible to handle the high voltage on the liquid ejection head 1 side without handling the high voltage on the printing apparatus main body side. Accordingly, it is possible to protect electronic circuits around the liquid ejection head 1 form the high voltage.

### Voltage Divider Circuit 910

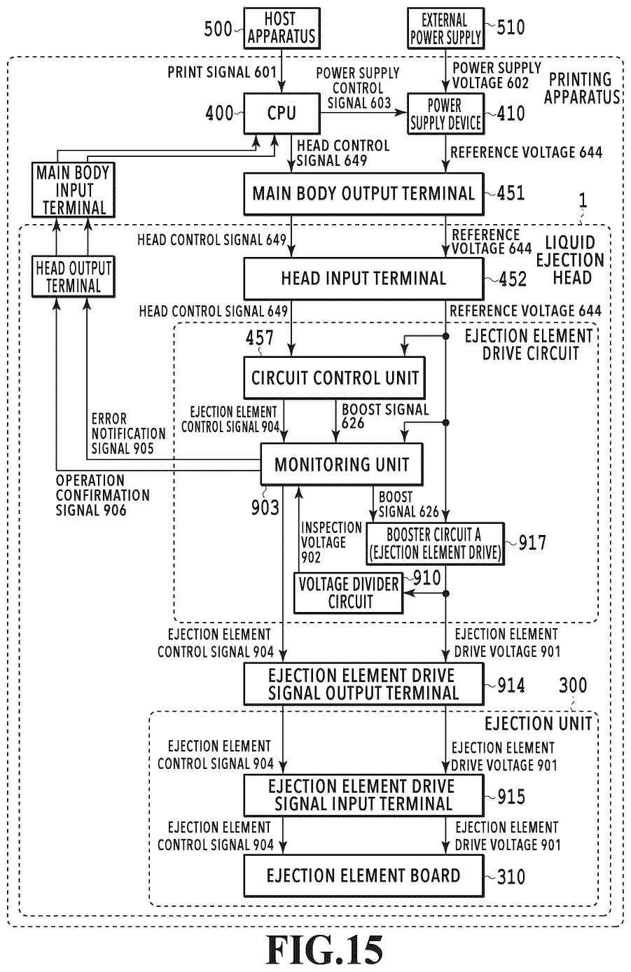

FIG. 15 is a block diagram in which the monitoring system of the ejection unit 300 according to the fourth embodiment includes the circuit control unit, the booster circuit, and the voltage divider circuit. In FIG. 14, explanation is given of an example in which the monitoring unit 903 monitors whether the ejection element drive voltage 901 is within the predetermined voltage range or not. In FIG. 15, explanation is given of an example in which the voltage divider circuit 910 is further provided, and the monitoring unit 903 monitors the divided voltage obtained by dividing the ejection element drive voltage 901.

For example, in the case where the inspection voltage 902 is a high voltage, devices with withstanding voltages capable of withstanding the inspection voltage 902 need to be selected as devices to be mounted in the monitoring unit 903. In this case, the size or the cost may increase. Moreover, there is a possibility that a degree of freedom in selection of the devices decreases. Accordingly, instead of inputting the ejection element drive voltage 901 directly into the monitoring unit 903 as the inspection voltage 902 as in FIG. 14, the inspection voltage 902 may be inputted into the monitoring unit 903 via the voltage divider circuit 910 as in FIG. 15. In other words, the ejection element drive voltage 901 is divided by the voltage divider circuit 910 into a lowered divided voltage which is inputted into the monitoring unit 903 as the inspection voltage 902, and thereby the monitoring unit 903 may monitor the ejection element drive voltage 901.

According to the above-mentioned explanation, the liquid ejection head 1 may further include the voltage divider circuit 910 that supplies the divided voltage, obtained by dividing the ejection element drive voltage, to the monitoring unit. The ejection element drive voltage 901 is divided by the voltage divider circuit 910 into a lowered divided voltage which is inputted into the monitoring unit 903 as the inspection voltage 902, and thereby the monitoring unit 903 may monitor the ejection element drive voltage 901. This configuration enables highly-sensitive monitoring of abnormality occurring in a transmission path. Moreover, breakage of the ejection element board 310 can be prevented.

### Fifth Embodiment

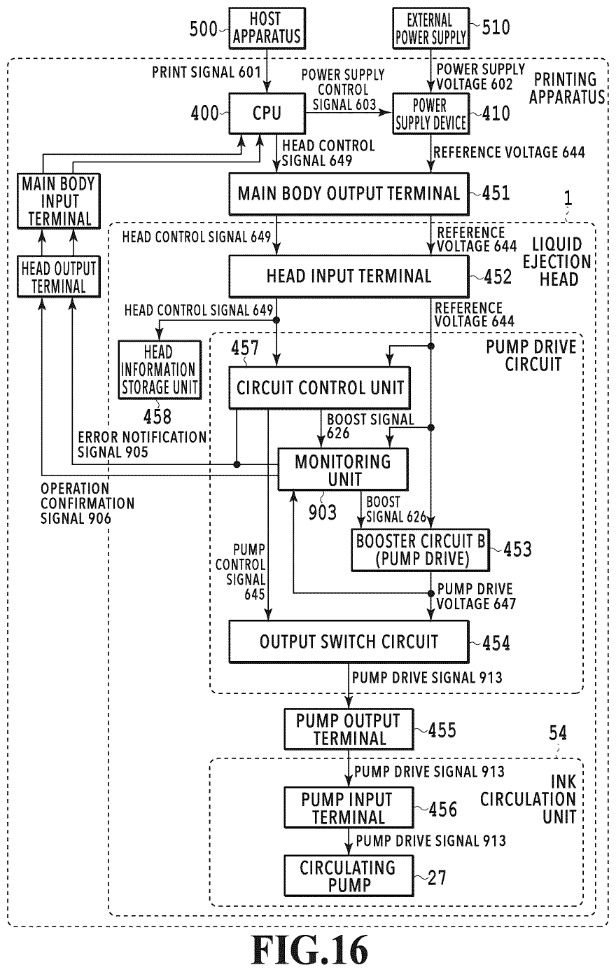

FIG. 16 is a block diagram in which a monitoring system of the ink circulation unit 54 according to a fifth embodiment includes a head information storage unit 458, the circuit control unit 457, a booster circuit B453, and an output switch circuit 454. The fifth embodiment is different from the first to third embodiments in that the circuit control unit 457, the booster circuit B453, and the output switch circuit 454 are provided in the liquid ejection head 1 as a pump drive circuit. Moreover, the fifth embodiment is different from the fourth embodiment in that drive control of the ink circulation unit 54 is performed. Differences from the first to fourth embodiments are mainly explained below.

The liquid ejection head 1 includes the pump drive circuit. In other words, in the present embodiment, unlike the third embodiment in which the pump drive signal 913 is generated outside the liquid ejection head 1, the pump drive signal 913 is generated inside the liquid ejection head 1. The pump drive circuit includes the circuit control unit 457, the booster circuit B453, and the output switch circuit 454. Moreover, the liquid ejection head 1 includes the head information storage unit 458. The head information storage unit 458 stores the head control signal 649. The circuit control unit 457, the booster circuit B453, and the output switch circuit 454 are provided in the head board 210. In other words, the monitoring unit 903, the circuit control unit 457, the booster circuit B453, and the output switch circuit 454 are provided in the head board 210. Therefore, the monitoring unit 903, the circuit control unit 457, the booster circuit B453, and the output switch circuit 454 are electrically connected in the same wiring system. Accordingly, in the case where the head board 210 is electrically affected depending on a surrounding environment of the head board 210, there is a possibility that the same offset occurs in a wiring circuit network of the head board 210.

### Circuit Control Unit 457; Monitoring Unit 903

The circuit control unit 457 receives the reference voltage 644 supplied from the power supply device 410, and the operation is started. In the present embodiment, 5 V is used as the reference voltage 644. The circuit control unit 457 receives the head control signal 649 supplied from the CPU 400. A logic circuit is provided inside the circuit control unit 457. The logic circuit outputs a pump control signal 645 to the output switch circuit 454 and the boost signal 626 to the monitoring unit 903, based on the head control signal 649. In the case where the monitoring unit 903 diagnoses that there is no abnormality in the boost signal 626, the monitoring unit 903 transmits the boost signal 626 to the booster circuit B453.

### Booster Circuit B453

The booster circuit B453 boosts the reference voltage 644 to a pump drive voltage 647 that is a voltage necessary for drive of the circulating pump 27, according to the boost signal 626. In the present embodiment, 66 V is used as the pump drive voltage 647. In other words, the booster circuit B453 boosts the reference voltage 644 of 5 V to the pump drive voltage 647 of 66 V. Moreover, the booster circuit B453 supplies the pump drive voltage 647 to the monitoring unit 903 via a branching path branching from a transmission path for transmitting the pump drive voltage 647 to the output switch circuit 454. The monitoring unit 903 diagnoses whether the pump drive voltage 647 is within a predetermined voltage range. In the case where the monitoring unit 903 diagnoses that the pump drive voltage 647 is not in the predetermined voltage range, the monitoring unit 903 diagnoses that the pump drive voltage 647 is abnormal, and outputs the error notification signal 905 to the CPU 400. In the case where the CPU 400 receives the error notification signal, the CPU 400 safely stops the drive of the circulating pump 27. Moreover, the monitoring unit 903 sends the operation confirmation signal 906 to the CPU 400 to indicate that the monitoring unit 903 normally functions. This operation causes the operation confirmation signal 906 not to be sent to the CPU 400 in the case where there is abnormality in the monitoring unit 903. Accordingly, in the case where the CPU 400 does not receive the operation confirmation signal 906 for a predetermined time period, the CPU 400 may detect that there is abnormality in the monitoring unit 903.

### Output Switch Circuit 454

The output switch circuit 454 generates the pump drive signal 913 based on the pump control signal 645 in a state where the pump drive voltage 647 is supplied to the output switch circuit 454. Specifically, the pump control signal 645 includes a first signal corresponding to the first electrode 272 and a second signal corresponding to the second electrode 274. The pump control signal 645 is active high. The pump control signal 645 is activated in the case where the voltage of the pump control signal 645 transitions from 0 V to 3.3 V. In the case where the pump control signal 645 transitions to active, the output switch circuit 454 outputs the pump drive signal 913 to the ink circulation unit 54 via the pump output terminal 455. The pump drive signal 913 includes one of a first pump drive signal corresponding to the first electrode 272 and a second pump drive signal corresponding to the second electrode 274. For example, in the case where the first signal transitions to active, the first pump drive signal is blocked, and in the case where the second signal transitions to active, the second pump drive signal is blocked. The first signal and the second signal alternately transition to active in a driving cycle. Potential differences varying in direction thereby alternately occur between the first electrode 272 and the second electrode 274 in the driving cycle, and the circulating pump 27 is driven. In other words, in the ink circulation unit 54, the pump drive signal 913 is transmitted to the circulating pump 27 via the pump input terminal 456 to drive the circulating pump, and the ink circulation operation is performed.

In the present embodiment, an FPGA is used for the circuit control unit 457, and the circuit control unit 457 needs to be a logic circuit device in which a setting value written in an internal register is rewritable, as in the fourth embodiment. In the meanwhile, in the monitoring unit 903 of FIG. 16, the setting value in the register is desirably locked to be non-rewritable as explained by using FIG. 7.

In the above explanation, the printing apparatus further includes the booster circuit B453 and the output switch circuit 454. The booster circuit B453 outputs the pump drive voltage 647 obtained by boosting the reference voltage 644. The output switch circuit 454 alternately outputs the first pump drive signal and the second pump drive signal in the driving cycle in the state where the pump drive voltage is supplied to the output switch circuit 454. The circulating pump 27 circulates the liquid according to the driving cycle based on the first pump drive signal and the second pump drive signal. The monitoring unit 903 sets the setting value to a boost setting value corresponding to the pump drive voltage, and the monitoring unit 903 monitors whether the pump drive voltage exceeds the setting value or not. In the configuration as described above, it is possible to handle the high voltage on the liquid ejection head 1 side without handling the high voltage on the printing apparatus main body side. Electric circuits around the liquid ejection head 1 can be thereby protected from the high voltage.

### Voltage Divider Circuit 910

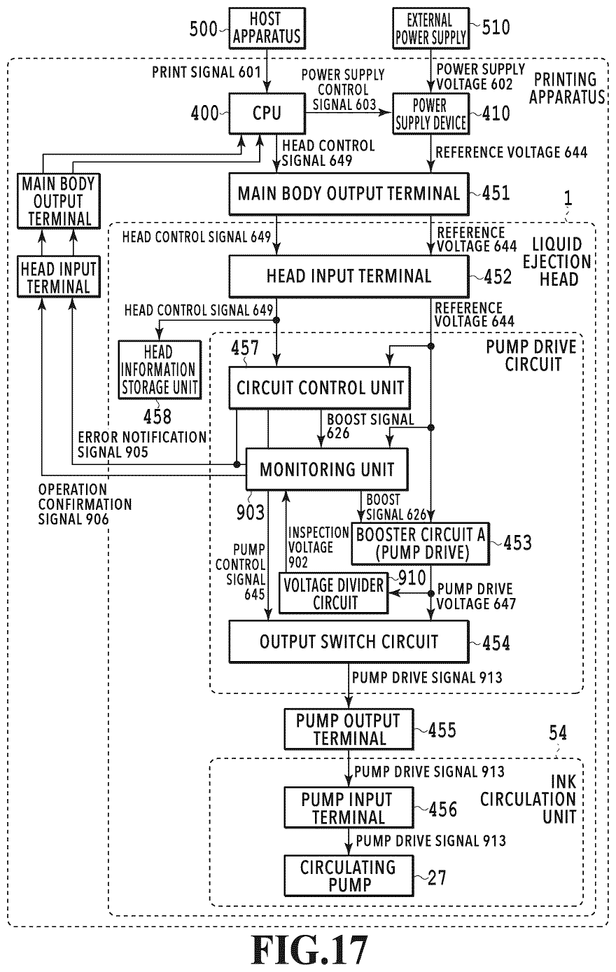

FIG. 17 is a block diagram in which the monitoring system of the ink circulation unit 54 according to the fifth embodiment includes the head information storage unit 458, the circuit control unit 457, the booster circuit B453, the voltage divider circuit 910, and the output switch circuit 454. In FIG. 16, explanation is given of an example in which the monitoring unit 903 monitors whether the pump drive voltage 647 is within the predetermined voltage range or not. In FIG. 17, explanation is given of an example in which the voltage divider circuit 910 is further provided, and the monitoring unit 903 monitors a divided voltage obtained by dividing the pump drive voltage 647, as the inspection voltage 902.

For example, in the case where the inspection voltage 902 is a high voltage, devices with withstanding voltages capable of withstanding the inspection voltage 902 need to be selected as devices to be mounted in the monitoring unit 903. In this case, the size or the cost may increase. Moreover, there is a possibility that a degree of freedom in selection of the devices decreases. Therefore, instead of inputting the pump drive voltage 647 directly into the monitoring unit 903 as the inspection voltage 902 as in FIG. 16, the inspection voltage 902 may be inputted into the monitoring unit 903 via the voltage divider circuit 910 as in FIG. 17. In other words, the pump drive voltage 647 is divided by the voltage divider circuit 910 into a lowered divided voltage which is inputted into the monitoring unit 903 as the inspection voltage 902, and thereby the monitoring unit 903 may monitor the pump drive voltage 647.

According to the above-mentioned explanation, the liquid ejection head 1 may further include the voltage divider circuit 910 that supplies the divided voltage, obtained by dividing the pump drive voltage, to the monitoring unit. The configuration may be such that the setting value is set to the divided voltage setting value corresponding to the divided voltage in the monitoring unit, and the monitoring unit monitors whether the divided voltage exceeds the setting value or not. This configuration enables highly-sensitive monitoring of abnormality occurring in a transmission path. Moreover, breakage of the circulating pump 27 can be prevented.

### Sixth Embodiment

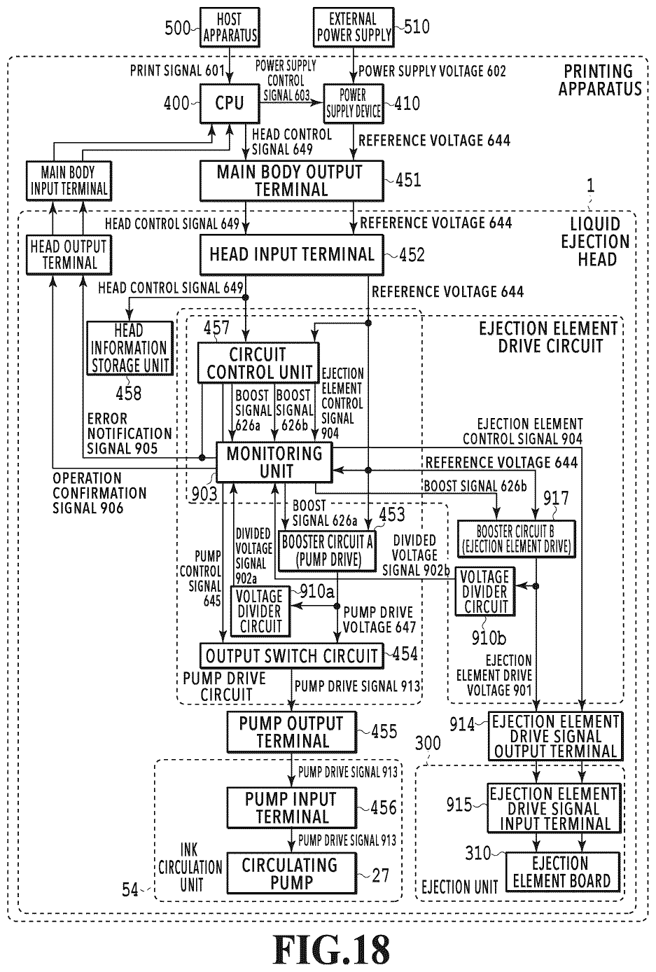

FIG. 18 is a block diagram in which a monitoring system of the ejection unit according to a sixth embodiment includes the circuit control unit 457, a booster circuit B917, and a voltage divider circuit 910b. Moreover, FIG. 18 is a block diagram in which a monitoring system of the ink circulation unit 54 includes the circuit control unit 457, a booster circuit A453, a voltage divider circuit 910a, and the output switch circuit 454. The sixth embodiment is different from the first to fifth embodiments in that the sixth embodiment has a configuration obtained by combining the fourth embodiment and the fifth embodiment. Differences from the first to fifth embodiments are mainly explained below.

The monitoring unit 903 monitors whether a voltage of a boost signal 626a to be transmitted to the booster circuit A453 is within a predetermined voltage range or not. In the case where the voltage of the boost signal 626a to be transmitted to the booster circuit A453 is not within the predetermined range, the monitoring unit 903 transmits the error notification signal 905 to the CPU 400. In the meanwhile, the monitoring unit 903 monitors whether a voltage of a boost signal 626b to be transmitted to the booster circuit B917 is within a predetermined voltage range or not. In the case where the voltage of the boost signal 626b to be transmitted to the booster circuit B917 is not within the predetermined voltage range, the monitoring unit 903 transmits the error notification signal 905 to the CPU 400.

The monitoring unit 903 monitors the pump drive voltage 647 as the voltage source of the pump drive signal 913 supplied to the circulating pump 27. In the meanwhile, the monitoring unit 903 monitors the ejection element control signal 904 supplied to the ejection element board 310, and monitors the ejection element drive voltage 901 supplied to the ejection element board 310. Note that, also in the present embodiment, in the case where the CPU 400 cannot confirm the output of the operation confirmation signal, the CPU 400 stops at least one of the drive of circulating the liquid and the drive of ejecting the liquid. The configuration in which the monitoring unit 903 is included inside the liquid ejection head 1 as described above can be applied to the liquid ejection head 1 that performs various types of signal transmission and signal generation. Moreover, including the monitoring unit 903 inside the liquid ejection head 1 enables accurate abnormality detection inside the liquid ejection head 1.

### Other Embodiments

Although explanation is given above by describing various examples and embodiments of the present disclosure, the spirit and the scope of the present disclosure are not limited to the specific explanation of the present specification. The present disclosure is not limited to the above-mentioned embodiments, and various modifications can be made. Moreover, in the present disclosure, parts of the above-mentioned embodiments may be combined as appropriate.

### Modified Example 1

For example, although the examples in which the printing apparatus operates in active high are explained, the present disclosure is not limited to this particular configuration. For example, the printing apparatus may operate in active low.

### Modified Example 2

Although the examples in which the setting value for monitoring used by the monitoring unit 903 are set to be non-rewritable are explained, the present disclosure is not limited to this particular configuration. Specifically, in the case where the circuit control unit 457 is provided inside the liquid ejection head 1 as in FIGS. 14 and 15 or FIGS. 16 and 17, both of the circuit control unit 457 and the monitoring unit 903 are provided in the head board 210 inside the liquid ejection head 1. Therefore, as explained in each of FIGS. 14 and 16, in the case where the circuit control unit 457 and the monitoring unit 903 are electrically affected depending on changes in the surrounding environment, there is a possibility that the same offset occurs in the wiring circuit network of the head board 210. In other words, since the monitoring of the drive voltage or the control signal is performed in the same wiring system, the setting value for monitoring used by the monitoring unit 903 does not have to be set to be non-rewritable. Note that, in the case where the monitoring unit 903 diagnoses that there is abnormality as a result of monitoring, the monitoring unit 903 may transmit the error notification signal 905 to the CPU 400, and the CPU 400 may stop the operation of the liquid ejection head 1. Moreover, in the case where the monitoring unit 903 diagnoses that there is abnormality as a result of monitoring, the operation may be stopped by performing control such that the various drive voltages or the various controls signals are not supplied to the booster circuit A453 and the like.

In other words, the liquid ejection head 1 includes the drive unit and the monitoring unit. The drive unit can perform at least one of the drive of circulating the liquid and the drive of ejecting the liquid based on the print signal. The monitoring unit sets at least one of the drive of circulating the liquid and the drive of ejecting the liquid as the monitoring target, and monitors at least one of the signal supplied to the monitoring target and the drive voltage supplied to the monitoring target based on the predetermined setting value. Moreover, in the case where the drive voltage exceeds the range determined by the setting value, the monitoring unit may stop supply of at least one the signal and the drive voltage to the monitoring target. In such a configuration, supply of at least one of the signal and the drive voltage that are the drive source of the operation is stopped even in the case where the liquid ejection head cannot normally operate. Accordingly, the drive of the liquid ejection head can be surely stopped. In other words, the liquid ejection head can be safely stopped even in the case where electrical abnormality occurs.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, safe stop is possible even in the case where electrical abnormality occurs.

This application claims the benefit of Japanese Patent Application No. 2024-202644, filed Nov. 20, 2024 which is hereby incorporated by reference herein in its entirety.

What is claimed is:

1. A liquid ejection head comprising:
a drive unit capable of performing at least one of drive of circulating liquid and drive of ejecting the liquid based on a print signal; and
a monitoring unit configured to set at least one of the drive of circulating the liquid and the drive of ejecting the liquid as a monitoring target, and monitor at least one of a signal supplied to the monitoring target and a drive voltage supplied to the monitoring target, based on a predetermined setting value, wherein
the setting value is set to be non-rewritable.

2. A liquid ejection head comprising:
a drive unit capable of performing at least one of drive of circulating liquid and drive of ejecting the liquid based on a print signal; and
a monitoring unit configured to set at least one of the drive of circulating the liquid and the drive of ejecting the liquid as a monitoring target, and monitor at least one of a signal supplied to the monitoring target and a drive voltage supplied to the monitoring target, based on a predetermined setting value, wherein
in a case where the drive voltage exceeds a range determined by the setting value, the monitoring unit stops supply of at least one of the signal and the drive voltage to the monitoring target.

3. The liquid ejection head according to claim 2, wherein the setting value is set to be non-rewritable.

4. The liquid ejection head according to claim 1, wherein, in a case where the drive voltage exceeds a range determined by the setting value, the monitoring unit stops supply of at least one of the signal and the drive voltage to the monitoring target.

5. The liquid ejection head according to claim 1, wherein, while the monitoring unit is continuing the monitoring based on the setting value, the monitoring unit outputs an operation confirmation signal indicating execution of the monitoring, to an outside.

6. The liquid ejection head according to claim 1, wherein, in a case where the drive voltage exceeds a range determined by the setting value, the monitoring unit transmits an error notification signal to an outside.

7. The liquid ejection head according to claim 2, wherein, while the monitoring unit is continuing the monitoring based on the setting value, the monitoring unit outputs an operation confirmation signal indicating execution of the monitoring, to an outside.

8. The liquid ejection head according to claim 2, wherein, in a case where the drive voltage exceeds the range determined by the setting value, the monitoring unit transmits an error notification signal to an outside.

9. The liquid ejection head according to claim 1, wherein
the drive unit includes an ejection element board configured to cause the liquid to be ejected, and
the monitoring unit monitors an ejection element control signal supplied to the ejection element board as the signal, and monitors an ejection element drive voltage supplied to the ejection element board as the drive voltage.

10. The liquid ejection head according to claim 9, further comprising a voltage divider circuit configured to supply a divided voltage, obtained by dividing the drive voltage, to the monitoring unit, wherein
the monitoring unit sets the setting value to a divided voltage setting value corresponding to the divided voltage, and the monitoring unit monitors whether the divided voltage exceeds the setting value or not.

11. The liquid ejection head according to claim 9, further comprising:
a signal generation circuit configured to output a drive signal generated based on the signal and the drive voltage; and
a peak hold circuit configured to supply an inspection voltage, generated based on a peak voltage of the drive signal, to the monitoring unit, wherein
the monitoring unit sets the setting value to a peak setting value corresponding to the inspection voltage, and the monitoring unit monitors whether the inspection voltage exceeds the setting value or not.

12. The liquid ejection head according to claim 9, further comprising:
a signal generation circuit configured to output a drive signal generated based on the signal and the drive voltage;
a voltage divider circuit configured to output a divided drive signal obtained by dividing a voltage of the drive signal; and
a peak hold circuit configured to supply an inspection voltage, generated based on a peak voltage of the divided drive signal, to the monitoring unit, wherein
the monitoring unit sets the setting value to a divided peak setting value corresponding to the inspection voltage, and the monitoring unit monitors whether the inspection voltage exceeds the setting value or not.

13. The liquid ejection head according to claim 1, further comprising:
a signal generation circuit configured to supply a pump drive signal generated based on the signal and the drive voltage; and
a peak hold circuit configured to supply an inspection voltage, generated based on a peak voltage of the pump drive signal, to the monitoring unit, wherein
the drive unit includes a circulating pump configured to circulate the liquid based on the pump drive signal, and
the monitoring unit sets the setting value to a pump setting value corresponding to the inspection voltage, and the monitoring unit monitors whether the inspection voltage exceeds the setting value or not.

14. The liquid ejection head according to claim 1, further comprising:
a signal generation circuit configured to supply a pump drive signal generated based on the signal and the drive voltage;
a voltage divider circuit configured to output a divided pump drive signal, obtained by dividing a voltage of the pump drive signal; and
a peak hold circuit configured to supply an inspection voltage, generated based on a peak voltage of the divided pump drive signal, to the monitoring unit, wherein
the drive unit includes a circulating pump configured to circulate the liquid based on the pump drive signal, and
the monitoring unit sets the setting value to a divided pump setting value corresponding to the inspection voltage, and the monitoring unit monitors whether the inspection voltage exceeds the setting value or not.

15. The liquid ejection head according to claim 1, further comprising a booster circuit configured to output an ejection element drive voltage obtained by boosting a reference voltage, wherein
the drive unit includes an ejection element board configured to cause the liquid to be ejected based on the ejection element drive voltage, and
the monitoring unit sets the setting value to a boost setting value corresponding to the ejection element drive voltage, and the monitoring unit monitors whether the ejection element drive voltage exceeds the setting value or not.

16. The liquid ejection head according to claim 15, further comprising a voltage divider circuit configured to supply a divided voltage, obtained by dividing the ejection element drive voltage, to the monitoring unit, wherein
the monitoring unit sets the setting value to a divided voltage setting value corresponding to the divided voltage, and the monitoring unit monitors whether the divided voltage exceeds the setting value or not.

17. The liquid ejection head according to claim 1, further comprising:
a booster circuit configured to output a pump drive voltage obtained by boosting a reference voltage; and
an output switch circuit configured to alternately output a first pump drive signal and a second pump drive signal in a driving cycle in a state where the pump drive voltage is supplied, wherein
the drive unit includes a circulating pump configured to circulate the liquid according to the driving cycle based on the first pump drive signal and the second pump drive signal, and
the monitoring unit sets the setting value to a boost setting value corresponding to the pump drive voltage, and the monitoring unit monitors whether the pump drive voltage exceeds the setting value or not.

18. The liquid ejection head according to claim 17, further comprising a voltage divider circuit configured to supply a divided voltage, obtained by dividing the pump drive voltage, to the monitoring unit, wherein
the monitoring unit sets the setting value to a divided voltage setting value corresponding to the divided voltage, and the monitoring unit monitors whether the divided voltage exceeds the setting value or not.

19. The liquid ejection head according to claim 1, wherein
the drive unit includes
an ejection element board configured to cause the liquid to be ejected, and
a circulating pump configured to circulate the liquid, and
the monitoring unit
monitors a control signal supplied to the ejection element board as the signal, and monitors a voltage supplied to the ejection element board as the drive voltage, and
monitors a pump drive voltage as the drive voltage, the pump drive voltage supplied as a voltage source of a pump drive signal supplied to the circulating pump.

20. A printing apparatus comprising:
a liquid ejection head;
a carriage configured to move the liquid ejection head in a scanning direction orthogonal to a conveyance direction of an ejection medium;
a conveyance unit configured to convey the ejection medium in the conveyance direction; and
a control unit configured to control the liquid ejection head, the carriage, and the conveyance unit, based on a print signal, and cause liquid to be ejected from the liquid ejection head to the ejection medium, wherein
the liquid ejection head includes
a drive unit capable of performing at least one of drive of circulating the liquid and drive of ejecting the liquid, based on the print signal,
a monitoring unit configured to set at least one of the drive of circulating the liquid and the drive of ejecting the liquid as a monitoring target, and monitor at least one of a signal supplied to the monitoring target and a drive voltage supplied to the monitoring target, based on a predetermined setting value, and
the setting value is set to be non-rewritable.

21. The printing apparatus according to claim 20, wherein, in a case where the control unit cannot confirm output of an operation confirmation signal indicating execution of the monitoring while the monitoring unit is continuing the monitoring based on the setting value, the control unit stops at least one of the drive of circulating the liquid and the drive of ejecting the liquid.

22. The printing apparatus according to claim 20, wherein, in a case where the control unit detects an error notification signal transmitted in a situation where the drive voltage exceeds a range determined by the setting value, the control unit stops at least one of the drive of circulating the liquid and the drive of ejecting the liquid.
